(19) United States
(12) Patent Application Publication
(10) Pub. No.: US 2015/0234618 A1
(43) Pub. Date: Aug. 20, 2015

(54) STORAGE MANAGEMENT COMPUTER, STORAGE MANAGEMENT METHOD, AND STORAGE SYSTEM

(71) Applicant: Hitachi, Ltd., Tokyo (JP)

(72) Inventors: Kyoko Miwa, Tokyo (JP); Katsunori Suzuki, Tokyo (JP); Yasutaka Kono, Tokyo (JP); Tsukasa Shibayama, Tokyo (JP); Satoshi Kaneko, Tokyo (JP); Yukinori Sakashita, Tokyo (JP)

(73) Assignee: Hitachi, Ltd., Tokyo (JP)

(21) Appl. No.: 14/425,722

(22) PCT Filed: Apr. 22, 2013
(86) PCT No.: PCT/JP2013/061784

§ 371 Date: Mar. 4, 2015

(51) Int. Cl. G06F 3/06

(52) U.S. Cl. CPC G06F 3/0647; G06F 3/0608; G06F 3/067

(57) ABSTRACT

When executing an instruction for changing a configuration of a virtual storage apparatus during an inter-enclosure data migration of storage apparatuses that provide the virtual storage apparatus, an appropriate command is issued to an appropriate storage apparatus.

A processor of a storage management computer is configured to acquire an operation instruction which instructs an operation for changing a configuration of a virtual storage apparatus that uses a first storage apparatus and a second storage apparatus, and when the operation instruction is executed during an inter-enclosure data migration from the first storage apparatus to the second storage apparatus, the processor selects a target storage apparatus among the first storage apparatus and the second storage apparatus based on the operation instruction and state information, generates an operation command that instructs an operation for changing a configuration of the target storage apparatus, and transmits the operation command to the target storage apparatus.

### TECHNICAL FIELD

The present invention relates to a technique for managing a configuration of storage.

### BACKGROUND ART

In recent years, the amounts of data used by companies and individuals have increased rapidly. In consideration thereof, storage systems utilizing techniques such as SAN (Storage Area Network) and NAS (Network Attached Storage) in which a storage apparatus and a host computer are coupled using a switch or a hub to enable flexible data management are being widely used. In addition, a technique is recently known for constructing a virtual storage apparatus on a physical storage apparatus in order to enable efficient utilization of a resource of a storage apparatus.

Furthermore, a control apparatus is known which enables an individually operating storage system to function as a component of a virtual storage system in a smooth manner (for example, PTL 1). The control apparatus stores identifier correspondence information that records first and second management identifiers for each of a plurality of management targets, receives a request specifying the first management identifier from a host apparatus, identifies a second management identifier that corresponds to the first management identifier specified in the received request from the identifier correspondence information, and outputs the identified second management identifier to a processing unit of a first storage system. The second management identifier is a management identifier of a type that is used for processing in the first storage system. The first management identifier is a management identifier of a type that is recognized by the host apparatus.

In addition, a volume migration method for migration of a replicated volume between storage apparatuses in a storage system made up of a plurality of storage apparatuses is known (for example, PTL 2). According to the volume migration method, when a migration of a copy source volume and a copy destination volume of a replicated volume is to be performed from a first storage apparatus for which a path to a virtualization apparatus is already configured to a second storage apparatus for which a path to the virtualization apparatus has not been configured, the virtualization apparatus configures a path between the virtualization apparatus and the second storage apparatus. When preparation of a differential bitmap is completed, the virtualization apparatus configures an access request to the volume so as to be made to the second storage apparatus instead of to the first storage apparatus.

Furthermore, a storage system is known which suppresses occurrence of overlapping I/O to improve responsiveness to a host during data migration (for example, PTL 3). In this storage system, a migration of data stored in a first volume that is included in a first storage apparatus is performed to a second volume that is included in a second storage apparatus, a migration state of the data from the first volume to the second volume is managed, an access request from a host apparatus to the second volume is processed, and an access destination of the host apparatus is switched to the first storage apparatus based on an access state to an unmigrated area of the second volume to which a migration of data has not yet been performed from the first volume.

### CITATION LIST

### Patent Literature

[PTL 1]
Japanese Patent Application Laid-open No. 2008-040571
[PTL 2]
Japanese Patent Application Laid-open No. 2007-115221 [PTL 3]
Japanese Patent Application Laid-open No. 2006-146476

### SUMMARY OF INVENTION

### Technical Problem

When a storage system including a virtual storage apparatus acquires an instruction of an operation for changing a configuration of the virtual storage apparatus, the storage system identifies an identifier of a physical resource corresponding to a virtual resource specified by the instruction based on the identifier of the virtual resource. When an inter-enclosure data migration of the physical resource that is an operation target is in progress, since a plurality of physical resources are associated with a virtual resource that is an operation target, it is conceivable that the operation may fail or that an operation such as unnecessary copying may occur and cause the performance of the storage system to decline.

### Solution to Problem

In order to solve the problem described above, a storage management computer that is an aspect of the present invention includes a communication control device coupled to a first storage apparatus and a second storage apparatus, a memory configured to store state information indicating states of the first storage apparatus and the second storage apparatus, and a processor coupled to the communication control device and the memory. The processor is configured to acquire an operation instruction which instructs an operation for changing a configuration of a virtual storage apparatus that uses the first storage apparatus and the second storage apparatus, and is configured to, when the operation instruction is executed during an inter-enclosure data migration from the first storage apparatus to the second storage apparatus, select a target storage apparatus from the first storage apparatus and the second storage apparatus based on the operation instruction and the state information, generate an operation command that instructs an operation for changing a configuration of the target storage apparatus, and transmit the operation command to the target storage apparatus.

### Advantageous Effects of Invention

According to an aspect of the present invention, when executing an instruction for changing a configuration of a virtual storage apparatus during an inter-enclosure data migration of a storage apparatus that provides the virtual storage apparatus, an appropriate command can be issued to an appropriate storage apparatus.

### BRIEF DESCRIPTION OF DRAWINGS

FIG. 1 shows a configuration of a computer system according to Example 1.

FIG. 2 shows a configuration of a storage apparatus 1000.

FIG. 3 shows a configuration of a host computer 2000.

FIG. 4 shows a configuration of a management computer 4000.

FIG. 5 shows a configuration of a virtual storage apparatus.

FIG. 6 schematically shows a relationship between the storage apparatus 1000 and a virtual storage apparatus 6000.

FIG. 7 schematically shows an inter-enclosure data migration.

FIG. 8 shows a configuration of a storage information table 4131.

FIG. 9 shows a configuration of a physical resource information table 4134.

FIG. 10 shows a configuration of a pool information table 4135.

FIG. 11 shows a configuration of a volume information table 413E.

FIG. 12 shows a configuration of a volume allocation information table 4139.

FIG. 13 shows a configuration of a copy pair information table 413A.

FIG. 14 shows a configuration of a processor performance information table 4141.

FIG. 15 shows a configuration of a port performance information table 4142.

FIG. 16 shows a configuration of a pool performance information table 4143.

FIG. 17 shows a configuration of a cache performance information table 4144.

FIG. 18 shows a configuration of a management task table 4150.

FIG. 19 shows a configuration of a management operation evaluation table 4161.

FIG. 20 shows a configuration of an evaluation rule table 4162.

FIG. 21 shows an inter-enclosure data migration registration process.

FIG. 22 shows a management operation registration process.

FIG. 23 shows a management task execution process.

FIG. 24 shows a first management operation conversion process.

FIG. 25 shows a configuration of a management computer 4000 according to Example 2.

FIG. 26 shows a configuration of a management operation expansion table 4163b.

FIG. 27 shows a configuration of an expansion rule table 4164b.

FIG. 28 shows a second management operation conversion process.

### DESCRIPTION OF EMBODIMENTS

Hereinafter, embodiments of the present invention will be described with reference to the drawings. In the drawings, elements sharing a same function may be displayed using a same numeral. Moreover, while the drawings represent specific embodiments and implementations based on principles of the present invention, it should be noted that the drawings are provided in order to facilitate understanding of the present invention and are not intended to be used to limit interpretation of the present invention.

While the present embodiment is described in sufficient detail for those skilled in the art to implement the present invention, it is to be understood that other implementations and modes are possible and that modifications of the configurations and structures and interchanging of various elements can be performed without departing from the scope and spirit of the technical ideas of the present invention. Therefore, the following description should not be interpreted as being limited thereto.

Furthermore, as will be described later, the present embodiment may be implemented by any of software running on a generic computer, dedicated hardware, or a combination of software and hardware.

Moreover, although information according to the embodiment will be described below using expressions such as an “aaa table”, the information may be expressed using concepts other than data structures such as a table. Therefore, in order to show that information is not dependent on data structure, for example, an “aaa table” may sometimes be referred to as “aaa information”.

Furthermore, while the expressions “identifier” and “ID” are used when describing contents of the respective pieces of information, these expressions are interchangeable.

While a “program” is sometimes used as a subject in the following description, since a program causes prescribed processing to be performed using a memory and a communication port (a communication control device) by being executed by a processor, a “processor” may be used as a subject in the following description. In addition, processing disclosed using a program as a subject may be considered processing performed by a computer or an information processing apparatus such as a management server. Furthermore, a program may be partially or entirely realized by dedicated hardware.

In addition, various programs may be installed in various computers from a program distribution server or via storage media that can be read by a computer.

Moreover, a management computer includes an input/output device. While conceivable examples of an input/output device include a display, a keyboard, and a pointer device, other devices may be used instead. Furthermore, by adopting a serial interface or an Ethernet interface as an alternative to an input/output device, coupling a display computer including a display, a keyboard, or a pointer device to the interface, and transmitting display information to the display computer or receiving input information from the display computer, input and display using an input/output device may be substituted by displaying on the display computer and accepting input from the display computer.

### Example 1

Hereinafter, a configuration of a computer system according to Example 1 will be described.

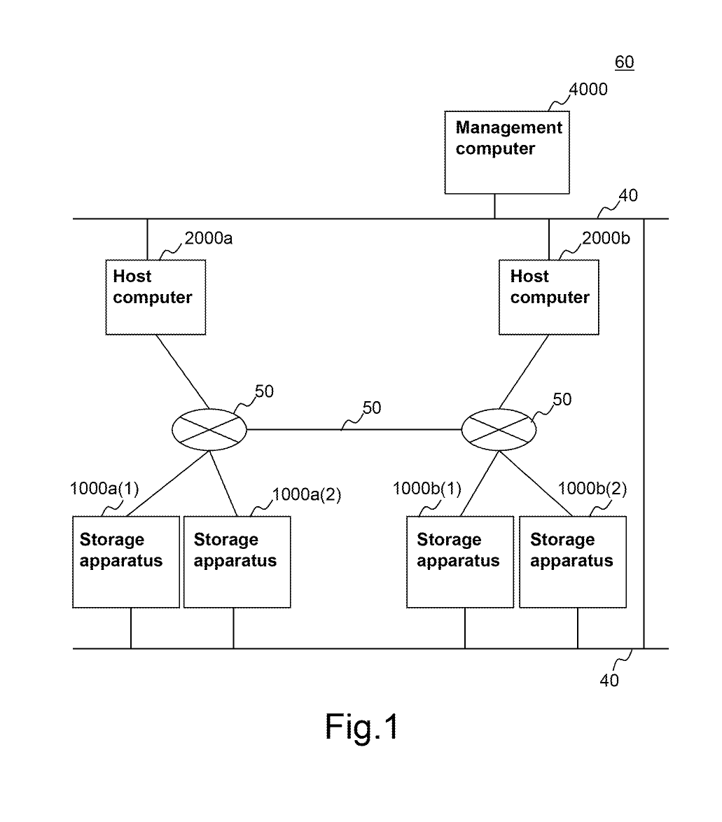

FIG. 1 shows a configuration of a computer system according to Example 1.

A computer system 60 includes storage apparatuses 1000a(1), 1000a(2), 1000b(1), and 1000b(2), a management computer 4000, host computers 2000a and 2000b, a management network 40, and a storage network 50. In the following description, the storage apparatuses 1000a(1), 1000a(2), 1000b(1), and 1000b(2) and the management computer 4000 may sometimes be referred to as a storage system.

Moreover, in the following description, when elements need not be distinguished from one another by an alphabetical letter or a parenthesized numeral following a numeral in a reference sign as in the case of the storage apparatuses 1000a(1), 1000a(2), 1000b(1), and 1000b(2), the alphabetical letter or the parenthesized numeral may sometimes be omitted.

The host computer 2000a and the storage apparatus 1000a are coupled to one another via the storage network 50. In a similar manner, the host computer 2000b and the storage apparatus 1000b are coupled to one another via the storage network 50. Furthermore, the storage apparatus 1000a and the storage apparatus 1000b are coupled to one another via the storage network 50.

Moreover, the host computer 2000a, the storage apparatus 1000a, the host computer 2000b, and the storage apparatus 1000b are coupled to the management computer 4000 via the management network 40.

The storage network 50 is a network that is primarily used for communication performed between the host computer 2000a and the storage apparatus 1000a based on an IO (Input/Output) request and communication performed between the host computer 2000b and the storage apparatus 1000b based on an IO request. Furthermore, the storage network 50 is used for communication for remote copying between the storage apparatus 1000a and the storage apparatus 1000b.

For example, a LAN (Local Area Network) or a SAN (Storage Area Network) can be adopted as the storage network 50. The storage network 50 may include a network switch, a hub, or the like. The storage network 50 according to the present example is an FC (Fiber Channel)-SAN based on a Fiber Channel protocol.

The management network 40 is a network used when the management computer 4000 manages the host computer 2000a, the storage apparatus 1000a, the host computer 2000b, and the storage apparatus 1000b. The management network 40 according to the present example is a LAN based on an IP (Internet Protocol) protocol. However, the configuration according to the present example does not necessarily deny that the storage network 50 and the management network 40 are formed on a single network. For example, when the storage network 50 is constituted by a network based on the IP protocol, the storage network 50 and the management network 40 may be formed on a single network.

While the storage apparatuses 1000a and 1000b basically share a same internal configuration, from an operational perspective, different roles are allocated to the storage apparatuses. Specifically, the storage apparatus 1000a is a primary storage apparatus that runs during normal operation and the storage apparatus 1000b is a secondary storage apparatus that stands by in preparation for a shutdown of the storage apparatus 1000a due to an occurrence of a failure or maintenance work. Accordingly, identity of data in a pair of volumes in the primary storage apparatus 1000a and the secondary storage apparatus 1000b is maintained by remote copying (mirroring).

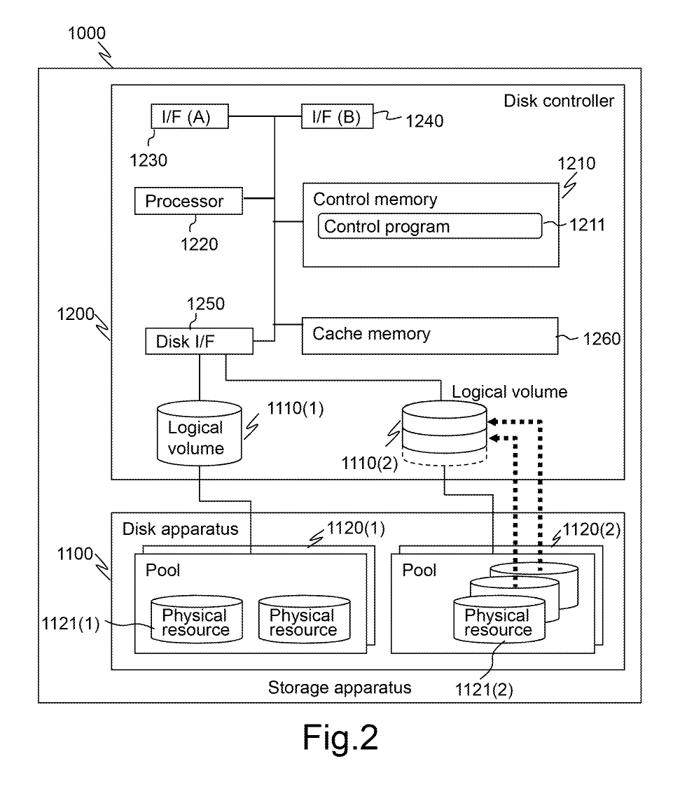

FIG. 2 shows a configuration of the storage apparatus 1000.

The storage apparatus 1000 includes a disk apparatus 1100 and a disk controller 1200.

The disk apparatus 1100 includes a pool 1120. The pool 1120 includes a physical resource 1121. In this case, the physical resource 1121 is a resource of a storage area provided by a medium (a storage medium) such as an HDD (Hard Disk Drive) or a SSD (Solid State Drive). Types of media that provide the physical resource 1121 are not particularly limited. The pool 1120 is a group of physical resources 1121. While the pool 1120 is a group of the physical resources 1121 that is made redundant according to a RAID (Redundant Array of Independent Disks), the pool 1120 may group one or more physical resources 1121 according to a method other than a RAID. While there are four pools 1120 and five physical resources 1121 in the drawing, this configuration is not restrictive and only one each of the pool 1120 and the physical resource 1121 need exist. The drawing schematically shows logical volumes 1110(1) and 1110(2) which are provided by the storage apparatus 1000. The pool 1120 coupled to the logical volume 1110(1) is constituted by a RAID and the pool 1120 coupled to the logical volume 1110(2) is configured so as to provide a capacity virtualization volume based on a Thin Provisioning technique or an Automated Tiering technique. However, this configuration is not restrictive and both pools 1120 may be constituted by a RAID or both pools 1120 may be configured so as to provide a capacity virtualization volume. Alternatively, the pool 1120 providing the capacity virtualization volume may be constructed by allocating the logical volume 1110 instead of the physical resource 1121 according to hardware specifications of the storage apparatus 1000. In this case, the physical resource 1121 constitutes the pool 1120 constituted by a RAID, the logical volume 1110(1) clipped from the pool 1120 constituted by the RAID is included in the pool 1120 providing the capacity virtualization volume, and the logical volume 1110(2) is clipped from the pool 1120 providing the capacity virtualization volume. The configuration of the pool 1120 that provides the capacity virtualization volume is not particularly limited.

The disk controller 1200 includes a control memory 1210, a processor 1220, a cache memory 1260, an I/F(A) 1230, an I/F(B) 1240, and a disk I/F 1250 that enables coupling to a disk apparatus. In this case, I/F stands for interface. The components in the disk controller 1200 are coupled via a bus.

The cache memory 1260 temporarily stores data in accordance with a write request received from the host computer 2000 and data read from the logical volume 1110 in response to a read request received from the host computer 2000.

Furthermore, the storage apparatus 1000 may additionally include an input device to be used by a user of the storage apparatus 1000 to input data, an output device for presenting information to the user of the storage apparatus 1000a, and the like.

In accordance with a program in the control memory 1210, the processor 1220 controls input/output of data in the control memory 1210 and input/output of data and control instructions via the respective I/Fs included in the disk controller 1200. A single storage apparatus 1000 may be equipped with a plurality of processors 1220 or a processing duty may be assigned to each processor 1220. For example, a logical volume 1110 for which a processor 1220 is responsible may be determined for each processor 1220.

The control memory 1210 stores programs and tables to be used by the processor 1220. For example, the control memory 1210 stores a control program 1211.

The control program 1211 is configured to perform processing of IO requests from the host computer 2000, processing for virtualizing a resource (processing capacity of the processor 1220, the control memory 1210, the cache memory 1260, the pool 1120, or the like) included in the storage apparatus 1000 to provide the resource as a virtual storage apparatus, inter-enclosure data migration and remote copying between a plurality of storage apparatuses 1000 that include physical resources 1121 allocated to the same virtual storage apparatus, processing instructed by the management computer 4000, and the like.

In addition, the control program 1211 provides functions as a storage including a function for creating the pool 1120 using the physical resource 1121, a function for generating the logical volume 1110 using the pool 1120, a function for allocating the logical volume 1110 to the host computer 2000 via the I/F(A) 1230, and a function for accepting a change request with respect to the configuration and settings of the storage apparatus 1000 from the management computer 4000.

The disk controller 1200 creates the logical volume 1110 using a part of the pool 1120. The logical volume 1110 is a logical storage area to which one or more physical resources 1121 is allocated and which is provided to the host computer 2000 by the disk controller 1200. In this case, one or a plurality of physical resources 1121 are allocated to the logical volume 1110(1) and a capacity of the logical volume 1110(1) and a total capacity of the constituent physical resources 1121 are equal to one another. However, when the physical resource 1121 is made redundant by a RAID, the capacity of the logical volume 1110(1) may sometimes be smaller than the total capacity of the constituent physical resources 1121. On the other hand, the logical volume 1110(2) is a virtual logical volume which is provided to the host computer 2000 and which is allocated a physical resource 1121 in response to a write request from the host computer 2000. Specifically, upon receiving a write request of data with respect to the logical volume 1110(2), when a physical resource 1221 is not allocated to a target area of the write request, the disk controller 1200 allocates the physical resource 1121 to the logical volume 1110(2) and writes the data into the allocated physical resource 1121. Accordingly, a storage capacity of the logical volume 1110(2) that is provided to the host computer 2000 can be made larger than a total capacity of the physical resources 1121 that are actually allocated. Such a technique is referred to as a Thin Provisioning technique. In addition, when allocating a plurality of physical resources 1121 to the logical volume 1110(2), types of media (HOD, SSD, and the like) that are providing sources of the physical resources 1121 may differ from one another. Furthermore, when the disk controller 1200 has an Automated Tiering function, the physical resource 1121 that is a storage destination of data written into the logical volume 1110(2) can be dynamically changed in accordance with an access frequency from the host computer 2000 or the like. For example, data with a high access frequency from the host computer 2000 is stored in the physical resource 1121 provided by a physical medium that enables high-speed access but is expensive such as an SSD, and data with a low access frequency from the host computer 2000 is stored in the physical resource 1121 provided by a physical medium that only enables low-speed access but is inexpensive such as an SATA (Serial Advanced Technology Attachment).

Moreover, while FIG. 2 shows one each of the two types of logical volumes 1110(1) and 1110(2) described above, this configuration is not restrictive and only one type or a combination of the two types of logical volumes may exist. The presence of one or more logical volumes 1110 may suffice.

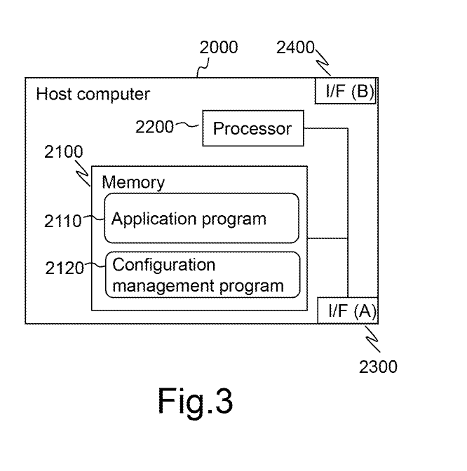

FIG. 3 shows a configuration of the host computer 2000.

The host computer 2000 includes a memory 2100, a processor 2200, an I/F(A) 2300, and an I/F(B) 2400. These components are coupled via a bus. The memory 2100 stores programs and data to be used by the processor 2200. For example, the memory 2100 stores an application program 2110 and a configuration management program 2120.

The application program 2110 is a program for performing an IO request to the storage system and may be any kind of program.

The configuration management program 2120 is a program for changing a configuration of the storage system. Based on an instruction from the management computer 4000, the configuration management program 2120 generates a command for changing the configuration of the storage system and issues (transmits) the command to the storage apparatus 1000. The command is issued by writing the command into a control volume in the logical volume 1110. When the command is written into the control volume, the storage apparatus 1000 executes an operation on a storage area specified by the written command. In other words, the storage apparatus 1000 must include at least one control volume in order to process a command.

In accordance with a program in the memory 2100, the processor 2200 controls input/output of data in the memory 2100 and input/output of data and control instructions via the I/F(A) 2300 or the I/F(B) 2400.

Furthermore, the host computer 2000a may additionally include an input device to be used by a user of the host computer 2000a to input data, an output device for presenting information to the user of the host computer 2000a, a secondary storage device for storing data, and the like.

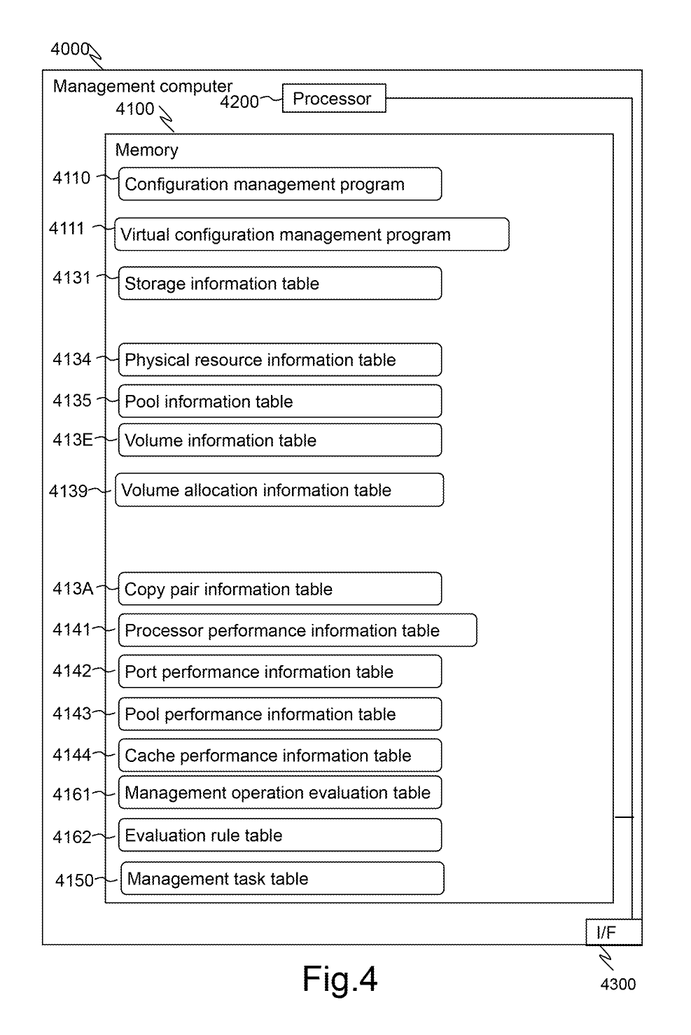

FIG. 4 shows a configuration of the management computer 4000.

The management computer 4000 includes a memory 4100, a processor 4200, and an I/F 4300.

The processor 4200 is configured to execute programs in the memory 4100, perform input/output of data into/from the memory 4100, perform input/output of data via the I/F 4300, transmit commands to the storage apparatus 1000 via the I/F 4300, and the like.

Furthermore, the management computer 4000 may additionally include an input device to be used by a user of the management computer 4000 to input data, an output device for presenting information to the user of the management computer 4000, a secondary storage device for storing data, and the like. In addition, the management computer 4000 may retain various tables in the memory 4100 in the secondary storage device.

Moreover, while the management computer 4000 and the storage apparatus 1000 are presented as separate apparatuses in the present example, this configuration is not restrictive and the management computer 4000 and the storage apparatus 1000 may coexist in a same enclosure. In addition, functions similar to those of the management computer 4000 may be realized by having the programs in the memory 4100 of the management computer 4000 be stored in the control memory 1210 of the storage apparatus 1000 and having the processor 1220 of the storage apparatus 1000 execute the programs.

The memory 4100 stores programs and tables to be used by the processor 4200.

For example, the memory 4100 stores a configuration management program 4110, a virtual configuration management program 4111, a storage information table 4131, a physical resource information table 4134, a pool information table 4135, a volume information table 413E, a volume allocation information table 4139, a copy pair information table 413A, a processor performance information table 4141, a port performance information table 4142, a pool performance information table 4143, a cache performance information table 4144, a management operation evaluation table 4161, an evaluation rule table 4162, and a management task table 4150.

Moreover, in the following description, the storage information table 4131, the physical resource information table 4134, the pool information table 4135, the volume information table 413E, the volume allocation information table 4139, and the copy pair information table 413A may sometimes be referred to as configuration information. In addition, the processor performance information table 4141, the port performance information table 4142, the pool performance information table 4143, and the cache performance information table 4144 may sometimes be referred to as performance information.

The management computer 4000 accepts input from a physical storage administrator who manages a plurality of physical storage apparatuses 1000 and from a virtual storage administrator who manages a virtual storage apparatus constructed using the storage apparatuses 1000. The physical storage administrator performs physical maintenance (for example, replacing a failed disk) of the storage apparatuses 1000, issues an instruction for allocating the physical resources 1121 to the virtual storage apparatus, issues an instruction for an inter-enclosure data migration, and the like. The virtual storage administrator issues an instruction for allocation of a virtual storage area provided by the virtual storage apparatus to the host computer, issues an instruction for copying a storage area or generating a backup of the storage area, and the like. An access right to the configuration management program 4110 is given to the physical storage administrator in advance. An access right to the virtual configuration management program 4111 is given to the virtual storage administrator in advance.

The configuration management program 4110 is a program for managing a configuration of a physical storage in the storage system in response to input from the physical storage administrator. The configuration management program 4110 provides a user interface for managing the physical storage to the user and transmits an operation such as an inter-enclosure data migration which has been accepted via the user interface to the storage apparatus 1000.

In addition, the configuration management program 4110 provides functions of a management computer including a function for collecting configuration information and performance information of the storage apparatus 1000 by communicating with the control program 1211 of the storage apparatus 1000, a function for creating a copy pair between the storage apparatus 1000a and the storage apparatus 1000b and operating the copy pair, a function for allocating the physical resource 1121 to the pool 1120, a function for generating the logical volume 1110 using the pool 1120, a function for allocating the logical volume 1110 to the host computer 2000 via the I/F(A) 1230, and a scheduler function for arranging particular processing to be performed at a particular time point.

Depending on the type of operation for managing the storage system, the configuration management program 4110 transmits a command to the storage apparatus 1000 via the configuration management program 2120 on the host computer 2000 or directly transmits a command to the storage apparatus 1000. Accordingly, a command for changing the configuration of the storage apparatus 1000 is generated and issued to the storage apparatus 1000 in a similar manner to the configuration management program 2120.

The virtual configuration management program 4111 is a program for managing a configuration of a virtual storage in the storage system in response to input from the virtual storage administrator. The virtual configuration management program 4111 provides a user interface for managing the virtual storage apparatus to the user and accepts operations of the virtual storage apparatus via the user interface.

Hereinafter, a virtual storage apparatus provided by the storage system will be described.

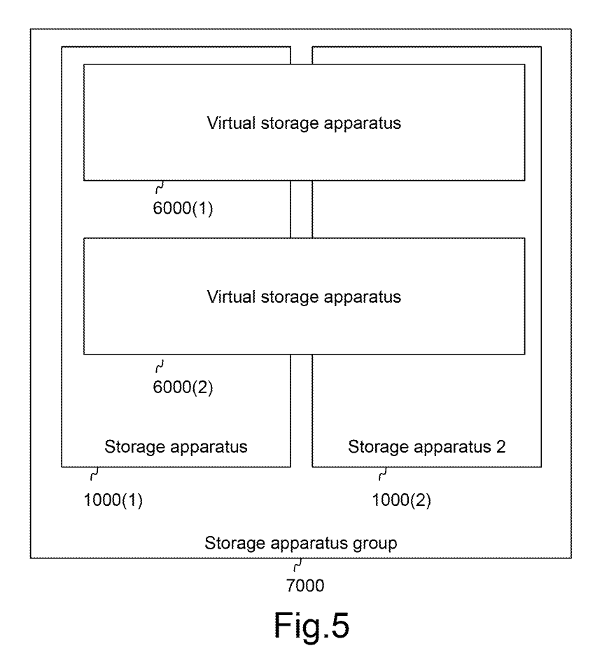

FIG. 5 shows a configuration of a virtual storage apparatus.

In the drawing, two virtual storage apparatuses 6000(1) and 6000(2) are constructed using two storage apparatuses 1000(1) and 1000(2). In addition a storage apparatus group 7000 that includes the two storage apparatuses 1000(1) and 1000(2) and the two virtual storage apparatuses 6000(1) and 6000(2) is constructed. For example, the virtual storage apparatus 6000(1) is constructed using the two storage apparatuses 1000(1) and 1000(2).

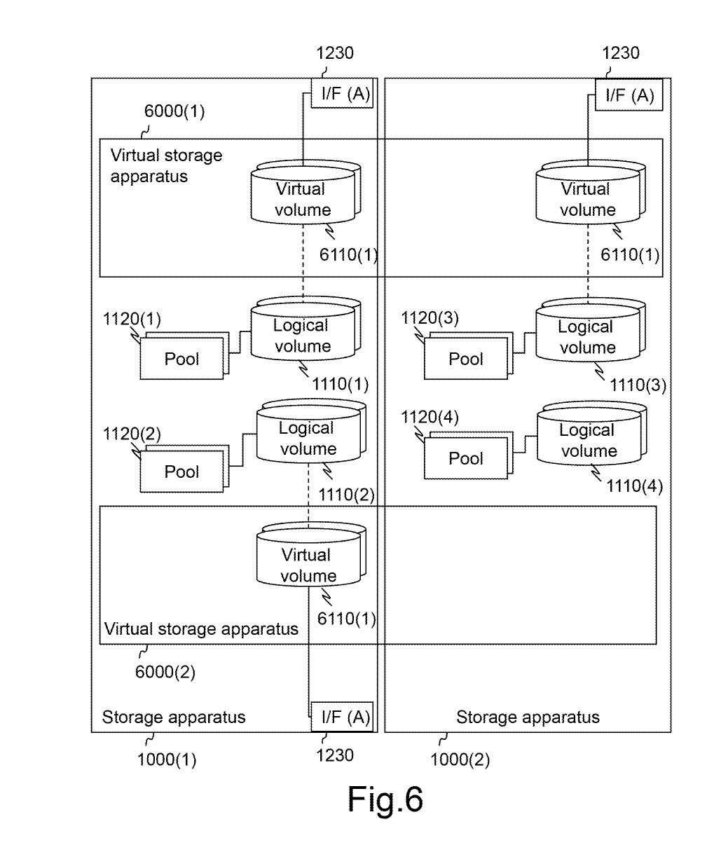

FIG. 6 schematically shows a relationship between the storage apparatus 1000 and the virtual storage apparatus 6000.

In the drawing, the disk controller 1200 allocates the logical volume 1110 that uses a part of the pool 1120 in the storage apparatus 1000 to the virtual volume 6110 in the virtual storage apparatus 6000. Moreover, there may be a logical volume not allocated to any of the virtual storage apparatuses 6000 among the plurality of logical volumes 1110(1), 1110(2), 1110(3), and 1110(4) such as the logical volume 1110(4). The pools 1120(1), 1120(2), 1120(3), and 1120(4) are respectively allocated to the logical volumes 1110(1), 1110(2), 1110(3), and 1110(4). In addition, while the drawing shows the disk controller 1200 allocating the logical volume 1110 in the storage apparatus 1000 to the virtual storage apparatus 6000, other resources of the storage apparatus 1000 (the processor 1220, the control memory 1210, the cache memory 1260, the I/F(A) 1230, the I/F(B) 1240, and the like) may be virtualized and allocated to the virtual storage apparatus 6000.

The virtual configuration management program 4111 accepts a management operation instruction (an operation instruction) for changing a configuration of the virtual storage apparatus 6000 (a configuration of virtual volumes in the virtual storage apparatus 6000). A management operation instruction instructs a virtual ID that is an identifier representing a virtual storage apparatus 6000 or a virtual volume 6110 that is a management operation target. A management operation includes a remote copying operation that is an operation with respect to a remote copy and a volume operation that is an operation with respect to the virtual volume 6110. In the following description, among a copy pair of remote copying, a copy source logical volume 1110 may sometimes be referred to as a copy source volume (a primary volume: P-VOL) and a copy destination logical volume 1110 may sometimes be referred to as a copy destination volume (a secondary volume: S-VOL). Remote copying involves specifying two volumes including the virtual volume 6110 as a copy pair and synchronizing the copy destination volume with the copy source volume. A remote copying operation includes a remote copy pair creation in which a copy pair of remote copying is created, suspend in which synchronization of a copy pair is suspended, resync (resynchronization) in which synchronization of a copy pair is resumed, and restore in which a copy source volume is overwritten by data stored in a copy destination volume. A volume operation includes a volume removal, in which, for example, the virtual volume 6110 is removed.

The configuration management program 4110 converts a management operation instruction accepted and registered by the virtual configuration management program 4111 into a management operation command (an operation command) for changing the configuration of the storage apparatus 1000 (a configuration of logical volumes in the storage apparatus 1000). A management operation command specifies a physical ID that is an identifier representing a storage apparatus 1000 or a logical volume 1110 that is a management operation target. A management operation command includes a remote copy operation and a volume operation in a similar manner to management operation.

Hereinafter, an inter-enclosure data migration in which data in a copy source logical volume of remote copying is migrated to a logical volume of another storage apparatus will be described. The enclosure in this case is the storage apparatus 1000. In the following description and in the drawings, an inter-enclosure data migration may sometimes be referred to as a data migration.

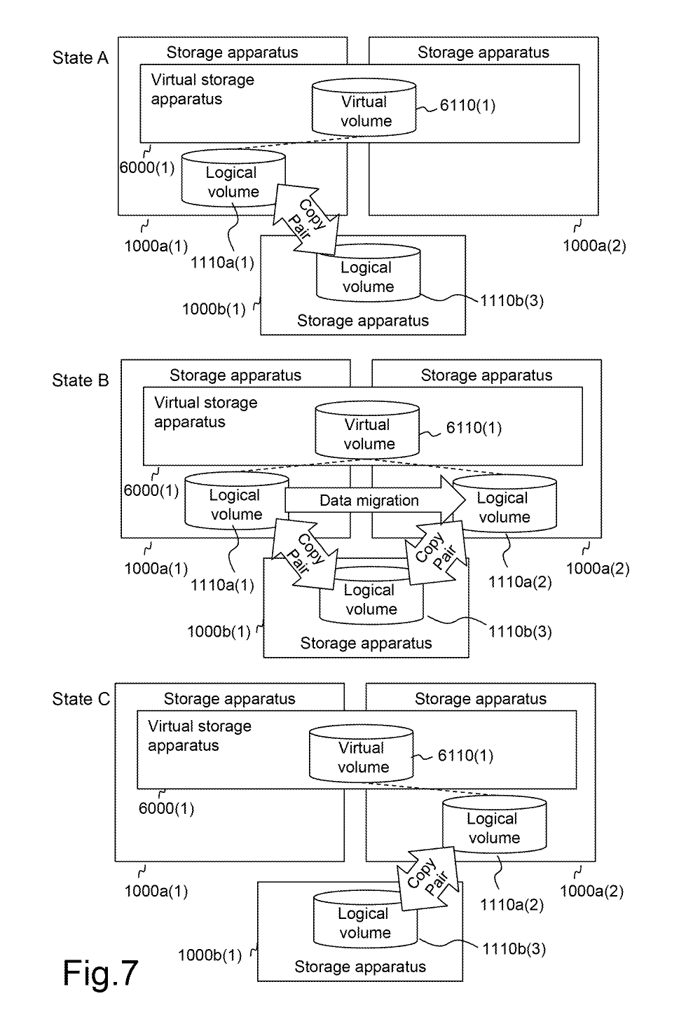

FIG. 7 schematically shows an inter-enclosure data migration.

The drawing shows a state A before the inter-enclosure data migration, a state B during the inter-enclosure data migration, and a state C after the inter-enclosure data migration in the storage system.

In the state A, a copy pair of remote copying is created which includes the logical volume 1110(1) in the storage apparatus 1000a(1) as a copy source and the logical volume 1110(3) in the storage apparatus 1000b(1) as a copy destination. In this case, the copy pair is in a state where the copy destination volume is to be synchronized with the copy source volume. Furthermore, the virtual storage apparatus 6000(1) is created using the storage apparatus 1000a(1) and the storage apparatus 1000a(2). In this case, the logical volume 1110(1) in the storage apparatus 1000a(1) is allocated to a virtual volume 6110(1) in the virtual storage apparatus 6000(1).

Subsequently, due to the execution of the inter-enclosure data migration using the logical volume 1110(1) in the storage apparatus 1000a(1) as a migration source volume and the logical volume 1110(2) in the storage apparatus 1000a(2) as a migration destination volume, the storage system enters the state B. At this point, the paired state of the logical volume 1110(1) and the logical volume 1110(3) is continued and, at the same time, a remote copy pair having the migration destination logical volume 1110(2) as a copy source and the logical volume 1110(3) as a copy destination is created. In addition, the logical volume 1110(1) and the logical volume 1110(2) are allocated to the virtual volume 6110. In this case, data prior to the migration in the logical volume 1110(1) is allocated to the virtual volume 6110, and data after the migration in the logical volume 1110(2) is allocated to the virtual volume 6110(1).

Subsequently, upon completion of the inter-enclosure data migration, the storage system enters the state C. At this point, the pairing of the logical volume 1110(1) and the logical volume 1110(3) is dissolved and the copy pair state of the logical volume 1110(2) and the logical volume 1110(3) is continued. In this case, the logical volume 1110(2) is allocated to the virtual volume 6110(1).

With the storage system according to the present example, since the host computer 2000 executes data read or write by specifying a virtual ID allocated to the virtual volume 6110(1) in any of the states of before the inter-enclosure data migration, during the inter-enclosure data migration, and after the inter-enclosure data migration, access to the virtual volume 6110(1) can be continued without having to consider the state of the inter-enclosure data migration. In the following description, the storage apparatus 1000 to which a migration source volume in the inter-enclosure data migration belongs may be referred to as a migration source storage and the storage apparatus 1000 to which a migration destination volume in the inter-enclosure data migration belongs may be referred to as a migration destination storage.

Hereinafter, tables stored in the management computer 4000 will be described.

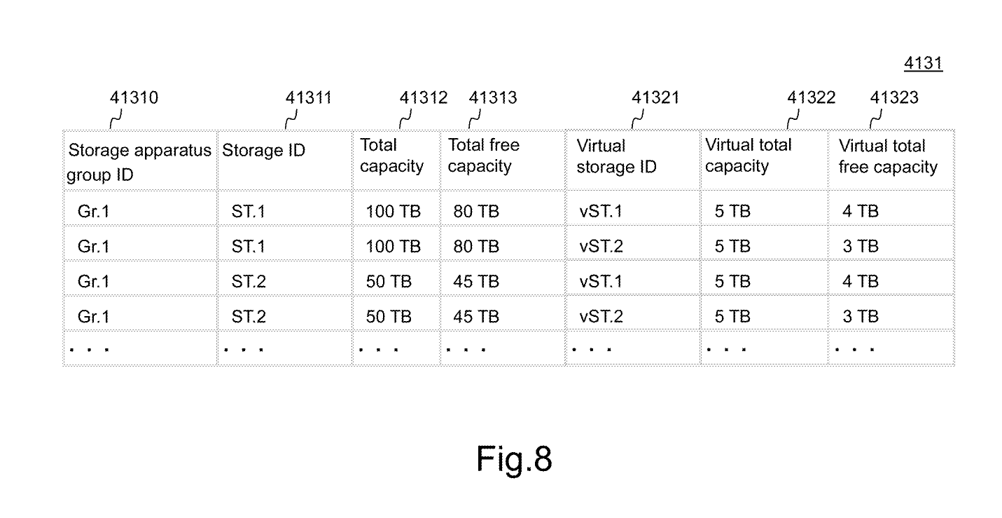

FIG. 8 shows a configuration of the storage information table 4131.

The storage information table 4131 shows information on the storage apparatus 1000, information on the virtual storage apparatus 6000, and information on an association between the storage apparatus 1000 and the virtual storage apparatus 6000. One entry in the storage information table 4131 corresponds to one combination of the storage apparatus 1000 and the virtual storage apparatus 6000.

The storage information table 4131 includes a storage perpendicular to the first and second end portions. The top apparatus group ID 41310 for identifying a storage apparatus group 7000 to which a certain storage apparatus 1000 belongs, a storage ID 41311 for identifying the storage apparatus 1000, a total capacity 41312 representing a sum of capacities of all pools 1120 included in the storage apparatus 1000, and a total free capacity 41313 representing a sum of amounts of free spaces of all pools 1120 included in the storage apparatus 1000. The storage information table 4131 further includes a virtual storage ID 41321 for identifying the virtual storage apparatus 6000 to which the storage apparatus 1000 is allocated, a virtual total capacity 41322 representing a sum of capacities of all virtual volumes 6110 included in the virtual storage apparatus 6000, and a virtual total free capacity 41323 representing a sum of amounts of free spaces of all virtual volumes 6110 included in the virtual storage apparatus 6000.

The storage information table 4131 is not limited to the information described above and may store other information on the storage apparatus 1000, other information on the virtual storage apparatus 6000, and other information on the association between the storage apparatus 1000 and the virtual storage apparatus 6000. Alternatively, information on the storage apparatus 1000, information on the virtual storage apparatus 6000, and information on the association between the storage apparatus 1000 and the virtual storage apparatus 6000 may be respectively stored in different tables. According to the storage information table 4131, the management computer 4000 can identify a storage apparatus 1000 and a virtual storage apparatus 6000 belonging to a certain storage apparatus group 7000 and can identify a virtual storage apparatus 6000 to which the physical resource 1121 of a certain storage apparatus 1000 has been allocated.

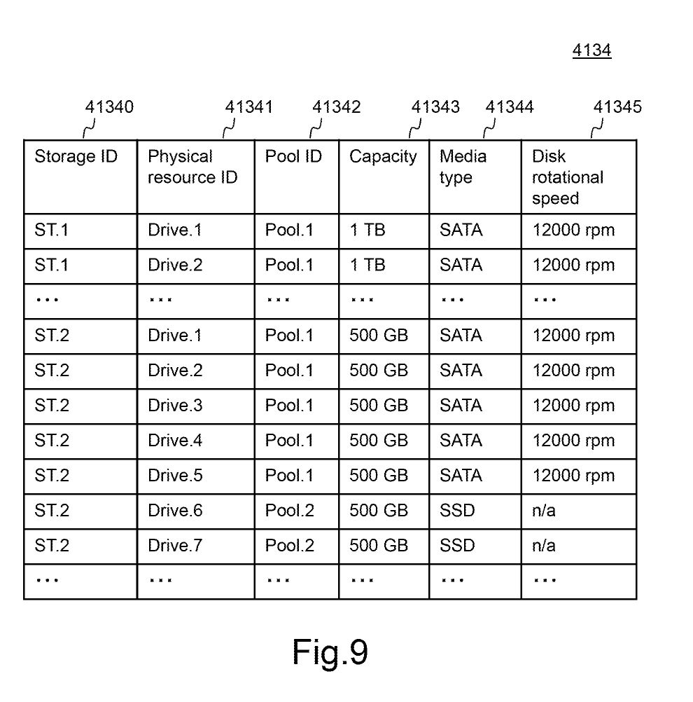

FIG. 9 shows a configuration of the physical resource information table 4134.

The physical resource information table 4134 is a table storing information on the physical resource 1121 in the storage apparatus 1000. One entry in the physical resource information table 4134 corresponds to one physical resource 1121. The physical resource information table 4134 includes a storage ID 41340 for identifying the storage apparatus 1000 to which a certain physical resource 1121 belongs, a physical resource ID 41341 for identifying the physical resource 1121, a pool ID 41342 for identifying the pool 1120 to which the physical resource 1121 is allocated, a capacity 41343 of the physical resource 1121, a medium type 41344 representing a type of medium of a providing source of the physical resource 1121, and a disk rotational speed 41345 of the medium of the providing source of the physical resource 1121. While values of the medium type 41344 assume one of “SATA” and “SSD” in the drawing, these values are not restrictive and any information representing a medium type may suffice. In addition, in the drawing, when the medium type 41344 is “SSD”, the disk rotational speed 41345 has a value of “n/a”. This indicates that an SSD does not include a disk and, accordingly, rotations of a disk do not occur. A method of indicating that rotations of a disk do not occur is not limited to the above and other methods of expression may be used. Furthermore, the physical resource information table 4134 is not limited to the information shown in the drawing and may store other information on the physical resource 1121.

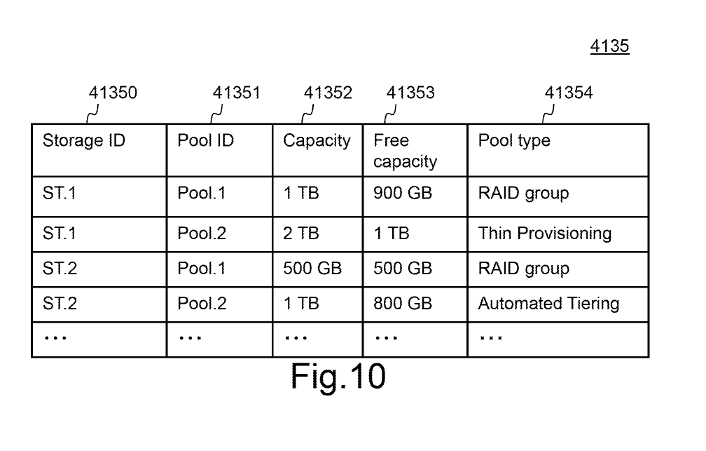

FIG. 10 shows a configuration of the pool information table 4135.

The pool information table 4135 is a table storing information on the pool 1120 included in the storage apparatus 1000. One entry in the pool information table 4135 corresponds to one pool 1120. The pool information table 4135 includes a storage ID 41350 for identifying a storage apparatus 1000 to which a certain pool 1120 belongs, a pool ID 41.351 for identifying the pool 1120, a capacity 41352 of the pool 1120, a free capacity 41353 of the pool 1120, and a pool type 41354 representing a type of the pool 1120. While values of the pool type 41354 assume one of “RAID group”, “Thin Provisioning”, and “Automated Tiering” in the drawing, these values are not restrictive and any information representing a type of the pool 1120 may suffice. Moreover, in the drawing, the pool 1120 whose pool type 41354 is “RAID group” is a pool that enables a capacity of one or a plurality of physical resources 1121 to be allocated in advance to the logical volume 1110(1). In addition, the pool 1120 whose pool type 41254 is “Thin Provisioning” is a pool that enables the physical resource 1121 to be allocated to the logical volume 1110(2) in response to a write request from the host computer 2000. Furthermore, the pool 1120 whose pool type 41254 is “Automated Tiering” is a pool to which the physical resource 1121 provided by a plurality of types of media is allocated and which enables the physical resource 1121 to be allocated to the logical volume 1110(2) in response to a write request from the host computer 2000, which enables a type of a providing source medium of the physical resource 1121 that is allocated to the logical volume 1110(2) to be changed in accordance with a frequency of I/O accesses to the logical volume 1110(2) from the host computer 2000 or the like, and which enables a migration of data written into a storage area of a physical resource 1121 that has already been allocated to be performed to a storage area on another physical resource 1121. In addition, the pool information table 4135 is not limited to the information shown in the drawing and may store other information on the pool 1120.

The configuration management program 4110 receives performance information on the storage apparatus 1000 and saves the performance information in the memory 4100 by periodically transmitting a request for performance information to the storage apparatus 1000. Accordingly, the management computer 4000 can select an operation target based on a load on a resource in the storage apparatus 1000.

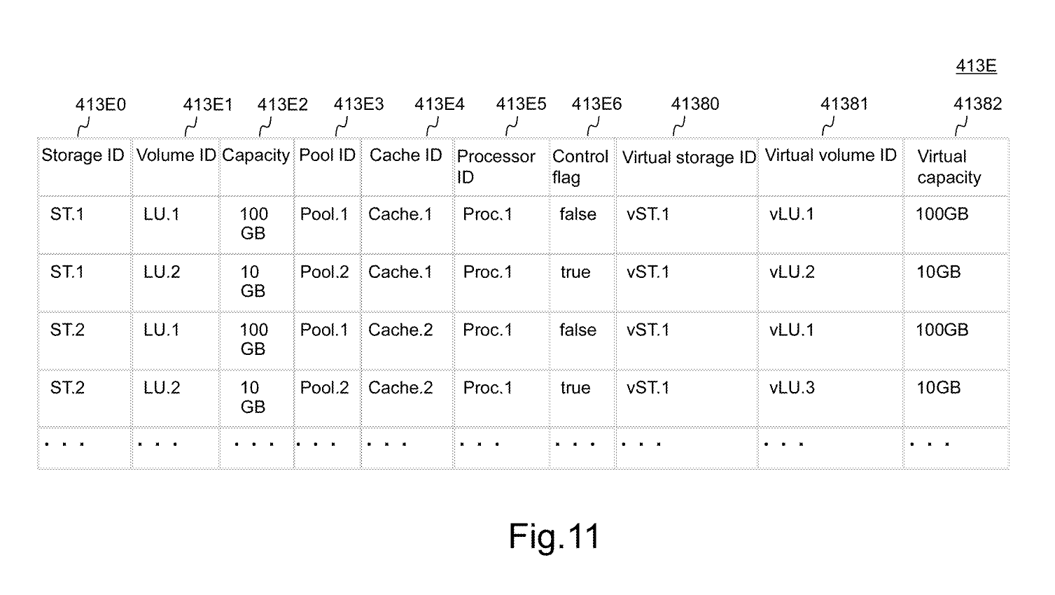

FIG. 11 shows a configuration of the volume information table 413E.

The volume information table 413E shows information on the logical volume 1110, information on the virtual volume 6110, and information representing an association between the logical volume 1110 and the virtual volume 6110. One entry in the volume information table 413E corresponds to one combination of the logical volume 1110 and the virtual volume 6110.

The volume information table 413E includes a storage ID 413E0 for identifying a storage apparatus 1000 to which a certain logical volume 1110 belongs, a volume ID 413E1 for identifying the logical volume 1110, a capacity 413E2 of the logical volume 1110, a pool ID 413E3 for identifying a pool 1120 that is an extraction source of the logical volume 1110, a cache ID 413E4 for identifying a cache memory 1260 that can be used by the logical volume 1110, a processor ID 413E5 for identifying a processor 1220 that can be used by the logical volume 1110, and a control flag 413E6 indicating whether or not the logical volume 1110 is a control volume. The volume information table 413E further includes a virtual storage ID 41380 for identifying a virtual storage apparatus 6000 to which a virtual volume 6110 related to the logical volume 1110 belongs, a virtual volume ID 41381 for identifying the virtual volume 6110, and a virtual capacity 41332 of the virtual volume 6110.

A control volume is an area into which a command for operating a storage area from the host computer 2000a is written. In the present example, a value of the control flag 413E6 is “true” when the logical volume 1110 is a control volume and “false” when the logical volume 1110 is not a control volume. In addition, the volume information table 413E is not limited to the information shown in the drawing and may store other information on the logical volume 1110, other information on the virtual volume 6110, and other information representing an association between the logical volume 1110 and the virtual volume 6110. Alternatively, information on the logical volume 1110, information on the virtual volume 6110, and information representing the association between the logical volume 1110 and the virtual volume 6110 may be respectively stored in different tables.

The drawing shows that two volumes, namely, a logical volume 1110(1) whose storage ID is “ST.1” and whose volume ID is “LU.1” and a logical volume 1110(2) whose storage ID is “ST.2” and whose volume ID is “LU.1” are allocated to a virtual volume 6110 whose virtual storage ID is “vST.1” and whose virtual volume ID is “vLU.1”. This means that an inter-enclosure data migration from the logical volume 1110(1) to the logical volume 1110(2) is in progress.

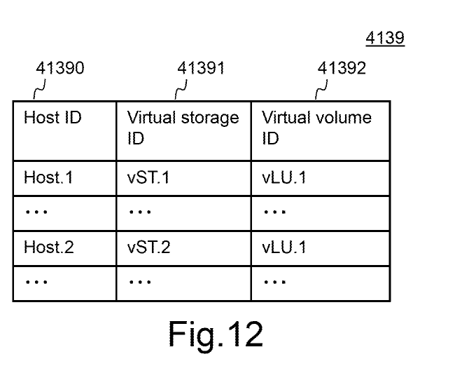

FIG. 12 shows a configuration of a volume allocation information table 4139.

The volume allocation information table 4139 is a table showing a relationship between the host computer 2000 and the virtual volume 6110 allocated to the host computer 2000. One entry in the volume allocation Information table 4139 corresponds to one combination of the host computer 2000 and the virtual volume 6110.

The volume allocation information table 4139 includes a host ID 41390 for identifying a certain host computer 2000, a virtual storage ID 41391 for identifying a virtual storage apparatus 6000 to which a virtual volume 6110 allocated to the host computer 2000 belongs, and a virtual volume ID 41392 for identifying the virtual volume 6110. The volume allocation information table 4139 is not limited to the information shown in the drawing and may store other information regarding the relationship between the host computer 2000 and the virtual volume 6110 allocated to the host computer 2000. Furthermore, the volume allocation information table 4139 may store information representing a relationship between the host computer 2000 and a logical volume 1110 allocated to the host computer 2000.

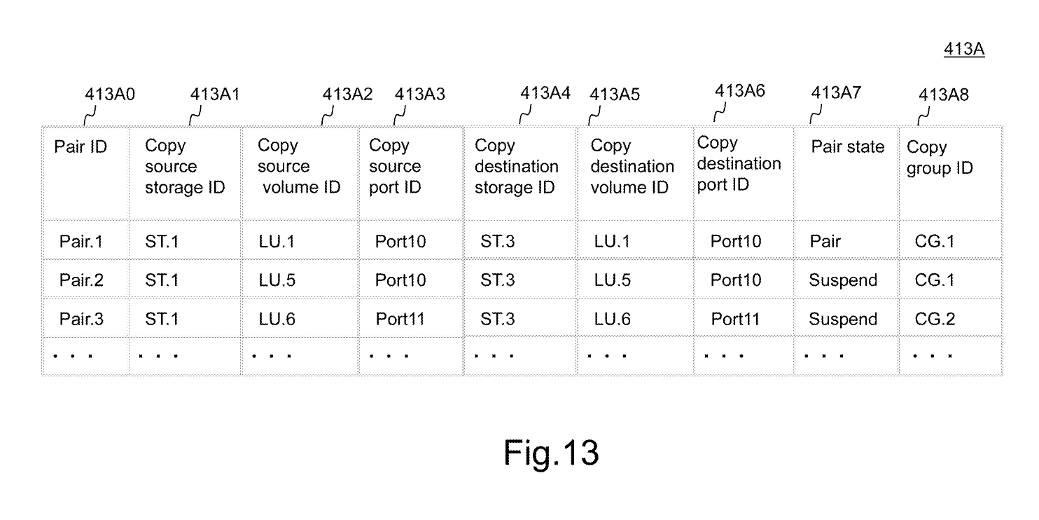

FIG. 13 shows a configuration of the copy pair information table 413A.

The copy pair information table 413A is a table showing a relationship between two logical volumes 1110 to form a copy pair in remote copying. One entry in the copy pair information table 413A corresponds to one copy pair.

The copy pair information table 413A includes a pair ID 413A0 for identifying a certain copy pair, a copy source storage ID 413A1 for identifying a copy source storage that is a copy source storage apparatus 1000 of the copy pair, a copy source volume ID 413A2 for identifying a copy source volume that is a copy source logical volume 1110 of the copy pair, a copy source port ID 413A3 for identifying a copy source port to be used for remote copying of the copy pair, a copy destination storage ID 413A4 for identifying a copy destination storage that is a copy destination storage apparatus 1000 of the copy pair, a copy destination volume ID 413A5 for identifying a copy destination volume that is a copy destination logical volume 1110 of the copy pair, a copy destination port ID 413A6 for identifying a copy destination port to be used for remote copying of the copy pair, a pair state 413A7 representing a state of the copy pair, and a copy group ID 413A8 for identifying a copy group to which the copy pair belongs. A copy pair belonging to a same copy group means that consistency of data is ensured. Logical volumes 1110 for which consistency of data is desirably ensured are registered to a same copy group. The ports shown in the copy source port ID 413A3 and the copy destination port ID 413A6 represent the I/F(A) 1230. Examples of values of the pair state 413A7 include “Pair” representing a state in which a copy pair is synchronized and “Suspend” representing a state in which synchronization of the copy pair is being suspended.

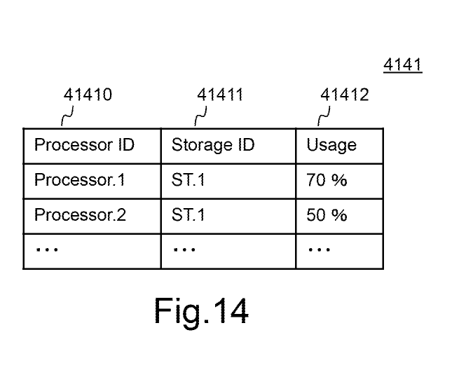

FIG. 14 shows a configuration of the processor performance information table 4141.

The processor performance information table 4141 is a table storing performance information of the processor 1220. One entry in the processor performance information table 4141 corresponds to one processor 1220.

The processor performance information table 4141 includes a processor ID 41410 for identifying a certain processor 1220, a storage ID 41411 for identifying a storage apparatus 1000 including the processor 1220, and usage 41412 representing usage of the processing capability of the processor 1220. An increase in load on the storage apparatus 1000 such as when there are many IO commands (read commands and write commands) to be processed results in a higher value of the usage 41412. For example, the value of the usage 41412 is obtained as a ratio [%] of an amount of IO commands that are actually being processed with respect to a maximum amount of IO commands that can be processed by the storage apparatus 1000. The processor performance information table 4141 is not limited to the information shown in the drawing and may store other information on the processor 1220.

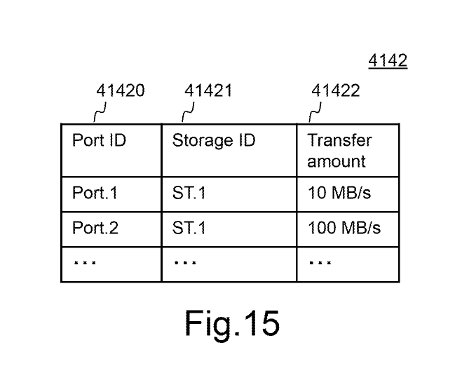

FIG. 15 shows a configuration of a port performance information table 4142.

The port performance information table 4142 is a table storing performance information of the I/F(A) 1230 (port). One entry in the port performance information table 4142 corresponds to one port.

The port performance information table 4142 includes an ID 41420 for identifying a port, a storage ID 41421 for identifying a storage apparatus 1000 that includes the port, and a transfer amount 41422 representing a transfer amount [MB/s] of the port. The port performance information table 4142 is not limited to the information shown in the drawing and may store other information on the port.

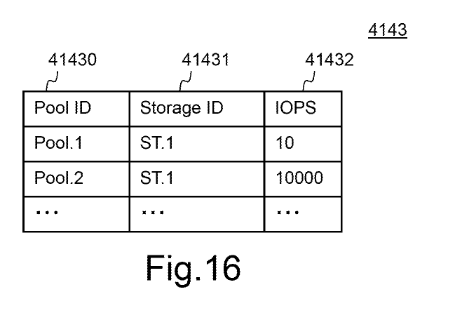

FIG. 16 shows a configuration of the pool performance information table 4143.

The pool performance information table 4143 is a table storing performance information of the pool 1120. One entry in the pool performance information table 4143 corresponds to one pool 1120.

The pool performance information table 4143 includes a pool ID 41430 for identifying a certain pool 1120, a storage ID 41431 for identifying a storage apparatus 1000 including the pool 1120, and IOPS 41432 representing the number of IOs per unit time (1 second) with respect to the pool 1120. The pool performance information table 4143 is not limited to the information shown in the drawing and may store other information on the pool 1120.

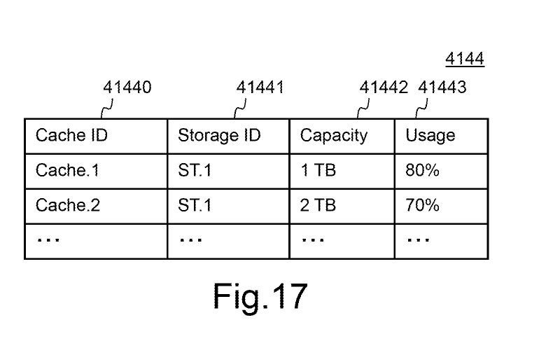

FIG. 17 shows a configuration of the cache performance information table 4144.

The cache performance information table 4144 is a table storing performance information of the cache memory 1260. One entry in the cache performance information table 4144 corresponds to one cache memory 1260.

The cache performance information table 4144 includes a cache ID 41440 for identifying a certain cache memory 1260, a storage ID 41441 for identifying a storage apparatus 1000 to which the cache memory 1260 belongs, a capacity 41442 of the cache memory 1260, and usage 41443 representing usage [%] of the cache memory 1260. The cache performance information table 4144 is not limited to the information shown in the drawing and may store other information on the cache memory 1260.

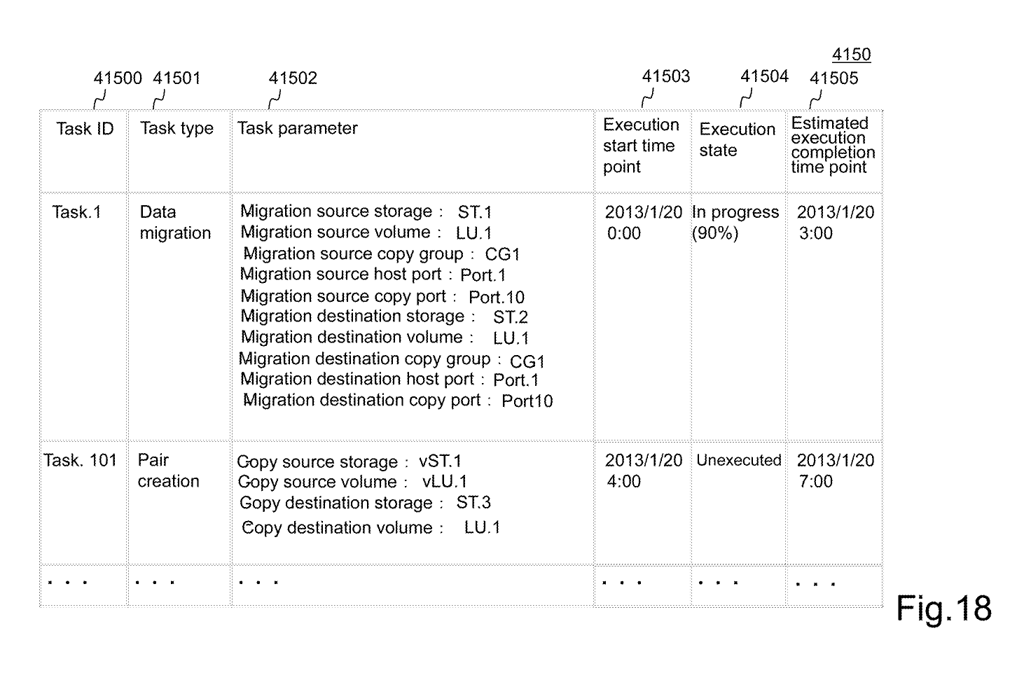

FIG. 18 shows a configuration of the management task table 4150.

The management task table 4150 is a table storing information on management tasks executed by the configuration management program 4110. A management task is registered in accordance with an instruction from the management computer 4000 and represents a management operation that is executed by the storage apparatus 1000. One entry in the management task table 4150 corresponds to one management task.

The management task table 4150 includes a task ID 41500 for identifying a certain management task, a task type 41501 representing the management task, a task parameter 41502 representing a parameter of the management task, an execution start time point 41503 representing an estimated start time point of execution of the management task or a time point at which execution of the management task had started, an execution state 41504 representing a state of execution of the management task, and an estimated execution completion time point 41505 representing an estimated completion time point of the execution of the management task.

An identifier representing a type of a management task is registered as the task type 41501. For example, when the management task is an inter-enclosure data migration, a value of the task type 41501 assumes “data migration”, and when the management task is a remote copy pair creation, the value of the task type 41501 assumes “remote copy pair creation”.

Parameters necessary for executing a management task are registered as the task parameter 41502. For example, when the management task is an inter-enclosure data migration, a migration source storage ID, a migration source volume ID, a migration source copy group ID, a migration source host port ID, a migration source copy port ID, a migration destination storage ID, a migration destination volume ID, a migration destination copy group ID, a migration destination host port ID, and a migration destination copy port ID are registered as the task parameter 41502. In addition, when the management task is a remote copy pair creation, a copy source storage ID, a copy source volume ID, a copy destination storage ID, and a copy destination storage ID are registered as the task parameter 41502.

In addition, when registering a management task, the configuration management program 4110 registers the execution start time point 41503 of the management task. Furthermore, during execution of the management task, the configuration management program 4110 updates the execution state 41504 of the management task and the estimated execution completion time point 41505 of the management task. For example, the execution state 41504 is information indicating whether the management task is “unexecuted” or “in progress” or information representing progress [%] of a management task that is “in progress”.

In the present example, when registering a management task, the virtual configuration management program 4111 registers a virtual ID such as a virtual storage ID or a virtual volume ID in the task parameter 41502. In addition, when issuing a command for a management operation to the storage apparatus 1000, the configuration management program 4110 converts an ID of an operation target from a virtual ID to a physical ID of a corresponding storage ID or logical volume ID. In doing so, the configuration management program 4110 may also register information regarding the physical ID having been converted from the virtual ID in the management task table 4150.

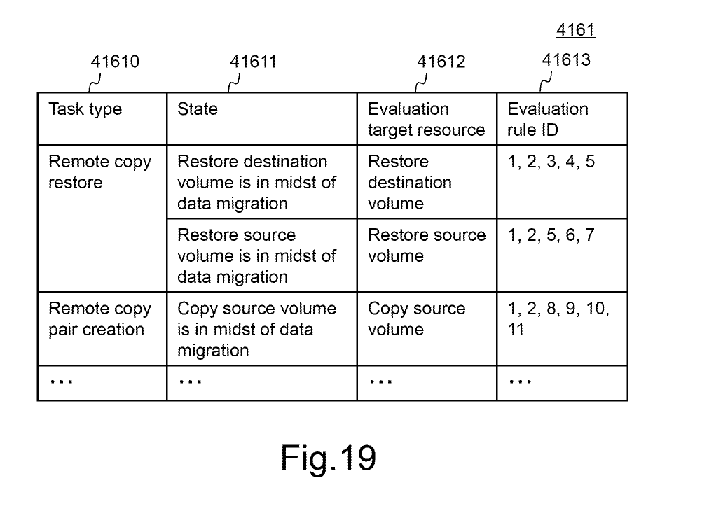

FIG. 19 shows a configuration of a management operation evaluation table 4161.

The management operation evaluation table 4161 is a table showing evaluation rules for evaluating a state of the storage system. One entry in the management operation evaluation table 4161 corresponds to one combination of a task type of a management task and a state of the storage system.

The management operation evaluation table 4161 includes a task type 41610 of a management task, a state 41611 of the storage system during execution of the management task, an evaluation target resource 41612 representing a resource that is an evaluation target, and an evaluation rule ID 41613 representing an evaluation rule corresponding to a combination of the management task and the state.

Each of a plurality of values shown in task type 41610 is a value that can be assumed by the task type 41501 in the management task table 4150. When execution of a management task in the task type 41610 is indicated and the state of the storage system is the state registered in the state 41611, the configuration management program 4110 evaluates a resource in the evaluation target resource 41612 using the evaluation rule shown in the evaluation rule ID 41613. In the following description, an evaluation rule whose evaluation rule ID is i (where i is an integer) may sometimes be referred to as an evaluation rule (i).

For example, when the virtual configuration management program 4111 registers a management task of a remote copy restore and the configuration management program 4110 issues a management operation command to the storage apparatus 1000 in accordance with the management task, if a restore destination volume (copy source volume, primary volume) is in the midst of an inter-enclosure data migration, by performing an evaluation using the evaluation rules (1), (2), (3), (4), and (5), a determination is made as to whether a virtual ID specified as the management task is to be converted into a physical ID of the logical volume 1110 that is a migration source or a physical ID of the logical volume 1110 that is a migration destination. In addition, when the virtual configuration management program 4111 registers a management task of a remote copy restore and the configuration management program 4110 issues a management operation command to the storage apparatus 1000 in accordance with the management task, if a restore source volume (copy destination volume, secondary volume) is in the midst of an inter-enclosure data migration, an evaluation using the evaluation rules (1), (2), (5), (6), and (7) is performed. Furthermore, when the virtual configuration management program 4111 registers a management task of a remote copy pair creation and the configuration management program 4110 issues a management operation command to the storage apparatus 1000 in accordance with the management task, if a copy source volume (primary volume) is in the midst of an inter-enclosure data migration, an evaluation using the evaluation rules (1), (2), (8), (9), (10), and (11) is performed.

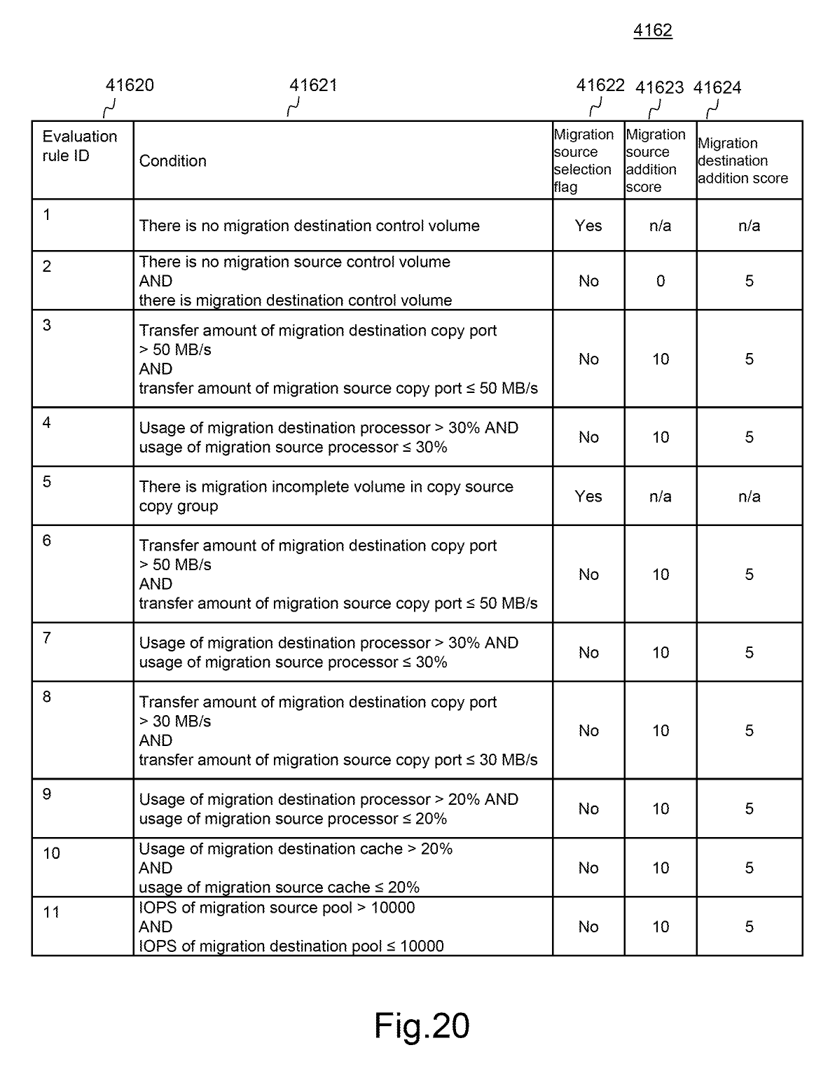

FIG. 20 shows a configuration of an evaluation rule table 4162.

The evaluation rule table 4162 shows rules for determining, when executing a management operation, whether the operation is to be performed on the logical volume 1110 included in a migration source storage that is a migration source storage apparatus 1000 or the operation is to be performed on the logical volume 1110 included in a migration destination storage that is a migration destination storage apparatus 1000. One entry in the evaluation rule table 4162 corresponds to one evaluation rule. When selecting a migration source storage or a migration destination storage as an operation target of a management operation, the configuration management program 4110 calculates a migration source score that is an evaluation value of the migration source storage and a migration destination score that is an evaluation value of the migration destination storage. After performing evaluations of all of the evaluation rules, the configuration management program 4110 selects the migration destination storage when the migration destination score is higher than the migration source score and, if not, selects the migration source storage.

The evaluation rule table 4162 includes an evaluation rule ID 41620, a condition 41621, a migration source selection flag 41622, a migration source addition score 41623, and a migration destination addition score 41624.

The evaluation rule ID 41620 is an identifier of a certain evaluation rule and corresponds to the evaluation rule ID 41613 in the management operation evaluation table 4161. The condition 41621 represents a condition of a state of the storage system which is determined by the evaluation rule.

The migration source selection flag 41622 represents whether or not the migration source storage is to be selected as an operation target when a state of an evaluation target resource satisfies the condition. The migration source addition score 41623 represents a value to be added to the migration source score when the state of the storage system satisfies the condition. The migration destination addition score 41624 represents a value to be added to the migration destination score when the state of the storage system does not satisfy the condition.

The evaluation rule (1) will be described. According to the management operation evaluation table 4161, the evaluation rule is applied when a remote copy restore or a remote copy pair creation is executed during an inter-enclosure data migration. The condition 41621 of the evaluation rule is that the number of logical volumes 1110 (migration destination control volumes) whose control flag is “true” in the migration destination storage is 0 or, in other words, there are no control volumes in the migration destination storage. When the state of the storage system meets this condition, since a command of a remote copy restore cannot be issued to the migration destination volume, the migration source selection flag 41622 of the evaluation rule is “Yes” and the migration source storage is selected as the operation target.

The evaluation rule (2) will be described. The condition 41621 of the evaluation rule is that the number of logical volumes 1110 (migration source control volumes) whose control flag is “true” in the migration source storage is 0 and the number of logical volumes 1110 (migration destination control volumes) whose control flag is “true” in the migration destination storage is larger than 0 or, in other words, there are control volumes in the migration destination storage but not in the migration source storage. Since the migration source storage is selected according to the evaluation rule (1) when there are no control volumes in the migration destination storage, a case that does not meet the condition of the evaluation rule (2) is a case where there are control volumes in both the migration source storage and the migration destination storage. In this case, management operations of volumes of both the migration source and the migration destination can be executed. However, since executing a management operation on the migration source necessitates performing a subsequent migration, the migration destination addition score 41624 of the evaluation rule is set higher than the migration source addition score 41623 of the evaluation rule.

The evaluation rule (3) will be described. According to the management operation evaluation table 4161, the evaluation rule applies to an evaluation when a remote copy restore is executed during an inter-enclosure data migration of a restore destination volume (copy source volume). The condition 41621 of the evaluation rule is that a transfer amount of a port (migration destination copy port) that is used for remote copying at the migration destination storage is higher than 50 MB/s and a transfer amount of a port (migration source copy port) that is used for remote copying at the migration source storage is lower than 50 MB/s. When a load on the migration destination copy port is higher than a prescribed value and a load on the migration source copy port is lower than a prescribed value, processing of a restore to the migration source volume takes place at a higher speed than processing of a restore to the migration destination volume. Therefore, the migration source addition score 41623 of the evaluation rule is set higher than the migration destination addition score 41624 of the evaluation rule.

The evaluation rule (4) will be described. The condition 41621 of the evaluation rule is that usage of the processor 1220 (migration destination processor) of the migration destination storage is higher than 30% and usage of the processor 1220 (migration source processor) of the migration source storage is lower than 30%. When a load on the migration destination processor is higher than a prescribed value and a load on the migration source processor is lower than a prescribed value, processing of a restore to the migration source volume takes place at a higher speed than processing of a restore to the migration destination volume. Therefore, the migration source addition score 41623 of the evaluation rule is set higher than the migration destination addition score 41624 of the evaluation rule.

The evaluation rule (5) will be described. The condition 41621 of the evaluation rule is that there is a logical volume 1110 (a migration incomplete volume) for which an inter-enclosure data migration to a copy group (a copy source copy group) to which the copy source volume belongs has not been completed. If the migration destination volume is selected as an operation target and a restore to the migration destination volume is performed in this state, a restore destination in the copy group includes the logical volume 1110 in the migration source storage and the logical volume 1110 in the migration destination storage. In other words, the copy source logical volume 1110 in the copy group straddles the migration source storage and the migration destination storage. This is effective when restrictions apply which, for example, prohibit a copy source in the copy group from straddling a plurality of storage apparatuses 1000. Conversely, the evaluation rule may be excluded when the copy source in the copy group is allowed to straddle a plurality of storage apparatuses 1000.

The evaluation rule (10) will be described. According to the management operation evaluation table 4161, this rule represents an evaluation in a case where the copy source volume is in the midst of an inter-enclosure data migration when executing a remote copy pair creation. The condition 41621 of the evaluation rule is that usage of the cache memory 1260 (migration destination cache) of the migration destination storage is higher than 20% and usage of the cache memory 1260 (migration source cache) of the migration source storage is lower than 20%. When a load on the cache memory 1260 used by the migration destination storage is higher than a prescribed value and, conversely, a load on the cache memory 1260 used by the migration destination storage is lower than a prescribed value, a remote copy pair creation using the migration source volume takes place at a higher speed than a remote copy pair creation using the migration destination volume. Therefore, the migration source addition score 41623 of the evaluation rule is set higher than the migration destination addition score 41624 of the evaluation rule.

In the present example, the usage of the cache memory 1260 is considered only when performing a remote copy pair creation and is not considered when performing other pair operations (restore and the like). This is because, when performing a remote copy pair creation, an initial copy of all data stored in the copy source volume is executed and load on the cache memory 1260 is emphasized from the perspective of performance, and when performing other pair operations, the load on the cache memory 1260 is not as emphasized as during a remote copy pair creation. Alternatively, an evaluation rule that takes the usage of the cache memory 1260 into consideration may be used in case of pair operations other than a remote copy pair creation.

The evaluation rule (6) and the evaluation rule (8) represent the same evaluation as the evaluation rule (3). However, in the case of the evaluation rule (8), a threshold of a transfer amount of a port is set lower than in the evaluation rule (3) to 30 MB/s. The evaluation rule (8) applies to a remote copy pair creation, and since a load during the initial copy of a remote copy pair creation is higher than a load during a restore, a condition that is more stringent than that of the evaluation rule (3) is set.

The evaluation rule (7) and the evaluation rule (9) represent the same evaluation as the evaluation rule (4). However, in the case of the evaluation rule (9), a threshold of the usage of the processor 1220 is set lower than in the evaluation rule (4) to 20%. The evaluation rule (9) applies to a remote copy pair creation, and since a load during the initial copy of a remote copy pair creation is higher than a load during a restore, a condition that is more stringent than that of the evaluation rule (4) is set.

The evaluation rule (11) will be described. The condition 41621 of the evaluation rule is that the IOPS of the pool 1120 (migration destination pool) to which the migration destination volume belongs is higher than 10000 and, at the same time, the IOPS of the pool 1120 (migration source pool) to which the migration source volume belongs is lower than 10000. When the load on the pool 1120 of the migration destination volume is high and, conversely, the load on the pool 1120 of the migration source volume is low, since a remote copy pair creation using the migration source volume takes place at a higher speed than a remote copy pair creation using the migration destination volume, the migration source addition score 41623 of the evaluation rule is set higher than the migration destination addition score 41624 of the evaluation rule.

In the present example, the load on the pool 1120 is considered only when performing a remote copy pair creation and is not considered when performing other pair operations (restore and the like). Alternatively, an evaluation rule that takes the load on the pool 1120 into consideration may be used in case of pair operations other than a remote copy pair creation.

In addition, the configuration management program 4110 may set the condition 41621, the migration source addition score 41623, the migration destination addition score 41624, and the like based on input from the physical storage administrator. Furthermore, the configuration management program 4110 may change the effect that each measurement value has on a migration source score or a migration destination score according to operations of the storage system.

This concludes the description of the tables stored in the memory 4100 of the management computer 4000.

Hereinafter, operations of the management computer 4000 will be described.

The configuration management program 4110 accepts an input from the physical storage administrator via the user interface and acquires an instruction to register the storage apparatus 1000 and the virtual storage apparatus 6000 based on the input. Subsequently, by communicating with the storage apparatus 1000 specified by the instruction, the configuration management program 4110 acquires configuration information of the storage apparatus 1000 and saves the configuration information in the tables in the memory 4100. The configuration management program 4110 then notifies completion of registration of the storage apparatus 1000 and the virtual storage apparatus 6000 to the physical storage administrator via the user interface. While examples of notification methods include a method of notification via a user interface such as a GUI (Graphical User Interface) or a CLI (Command Line Interface) and a method involving outputting a message to a log, the notification method is not particularly limited. In this case, when a virtual storage apparatus 6000 using the storage apparatus 1000 is specified by the instruction, the configuration management program 4110 generates configuration information of the virtual storage apparatus 6000 based on the configuration information of the storage apparatus 1000 and stores the configuration information of the virtual storage apparatus 6000 in the tables in the memory 4100.

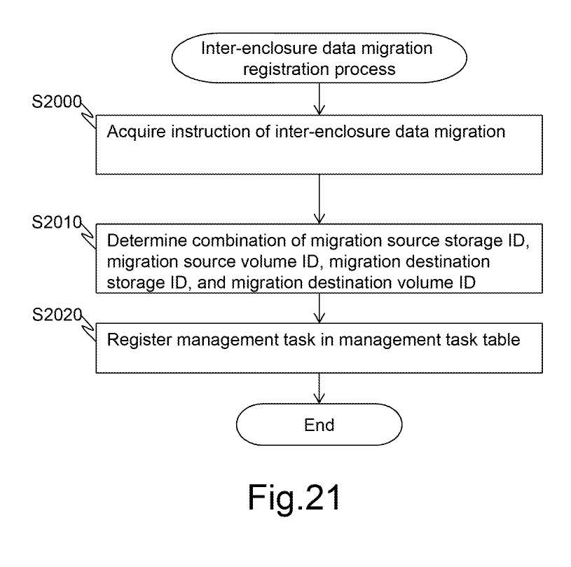

FIG. 21 shows an inter-enclosure data migration registration process.

In the inter-enclosure data migration registration process, the configuration management program 4110 registers a management task of an inter-enclosure data migration based on an input from the physical storage administrator.

In step S2000, the configuration management program 4110 accepts an input of an instruction for the inter-enclosure data migration from the physical storage administrator via the user interface and acquires an instruction for the inter-enclosure data migration based on the input. The instruction may be made by specifying physical IDs of a migration source storage, a migration destination storage, and the like or by specifying physical IDs of a migration source volume, a migration destination volume, and the like.

In step S2010, based on the acquired instruction, the configuration management program 4110 determines a set made up of a migration source storage ID, a migration source volume ID, a migration destination storage ID, and a migration destination volume ID. At this point, the configuration management program 4110 also determines a port to be used by the migration destination storage. In addition to a port accessed from the host computer 2000, when the migration source volume is a logical volume 1110 included in a remote copy pair, the port includes a port used for remote copying. Moreover, when the migration source volume and the migration destination volume are specified in S2000, the configuration management program 4110 determines a set made up of a migration source storage ID, a migration source volume ID, a migration destination storage ID, and a migration destination volume ID based on specified contents.

In step S2020, the configuration management program 4110 registers information regarding the instructed inter-enclosure data migration as a management task in the management task table 4150 and terminates the present flow.

This concludes the description of the inter-enclosure data migration registration process. According to the process, the management computer 4000 can register a management task of an inter-enclosure data migration.

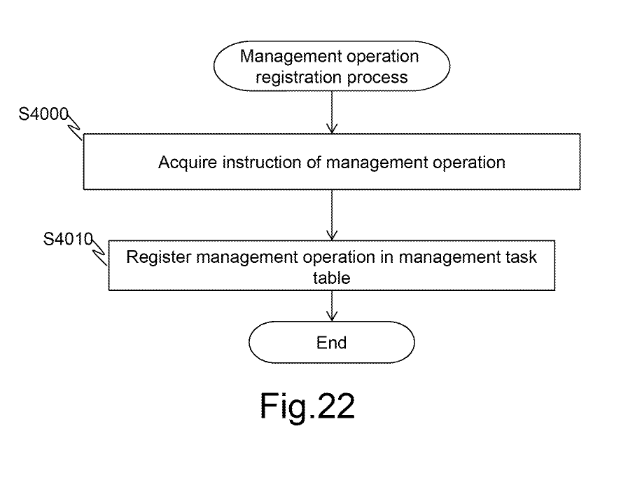

FIG. 22 shows a management operation registration process.

In the management operation registration process, the virtual configuration management program 4111 registers a management task based on input from the virtual storage administrator.

In step S4000, the virtual configuration management program 4111 accepts an input of an instruction for a management operation from the virtual storage administrator via the user interface and acquires an instruction for the management operation based on the input. The instruction specifies a virtual operation target that is a target of the management operation. The virtual operation target is specified according to a virtual storage ID of the virtual storage apparatus 6000 and a virtual ID such as a virtual volume ID. When the instruction is for a pair operation with respect to remote copying, the instruction specifies a virtual storage ID of the virtual storage apparatus 6000 including a copy source volume, a virtual volume ID of the copy source volume, a virtual storage ID of the virtual storage apparatus 6000 including a copy destination volume, and a virtual volume ID of the copy destination volume. In addition, the instruction may specify a time point (a start time point) at which a command of the management operation is to be transmitted to the storage apparatus 1000.

In step S4010, based on the acquired instruction, the virtual configuration management program 4111 registers information regarding the management operation as a management task in the management task table 4150 and terminates the present flow.

This concludes the description of the management operation registration process. According to this process, the virtual configuration management program 4111 can register a management operation to be performed on the virtual storage apparatus 6000. Moreover, when the virtual storage administrator desires to immediately execute the management operation on the virtual storage apparatus 6000, a current time point may be specified as the execution start time point 41503 in the management task table 4150. Alternatively, based on input from the physical storage administrator, the configuration management program 4110 may register a management operation that specifies a physical ID in the management task table 4150.

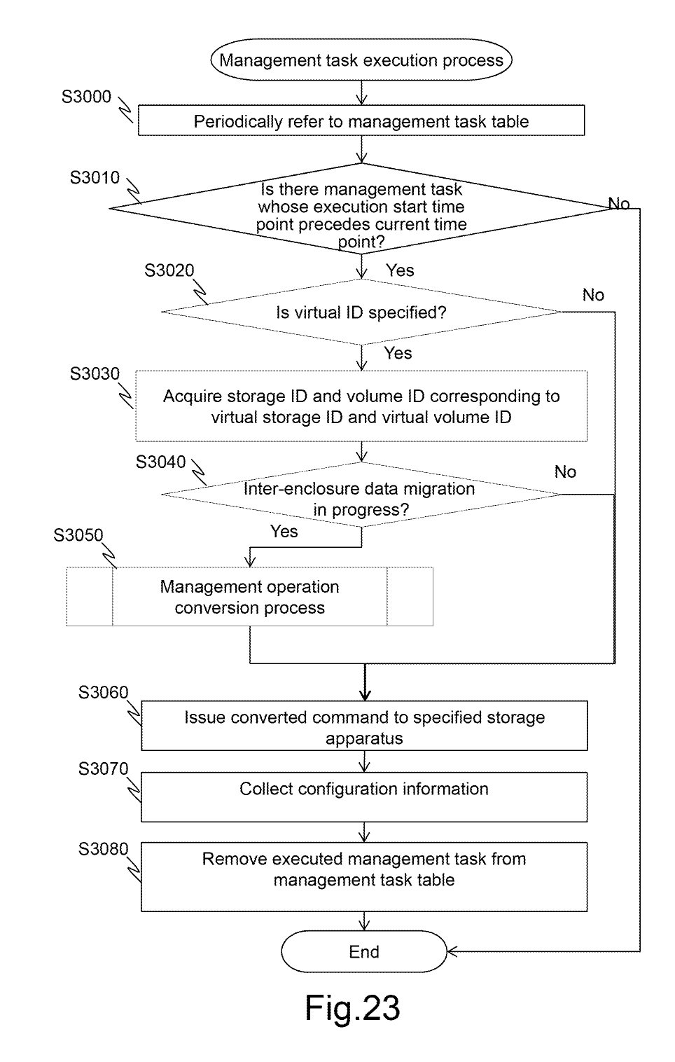

FIG. 23 shows a management task execution process.

In the management task execution process, the configuration management program 4110 executes a management task that has already been registered. Examples of the management task include an inter-enclosure data migration registered by an inter-enclosure data migration registration process or a management operation registration process and management operations (a remote copy pair creation, a remote copy restore, and the like). The management task execution process is periodically executed. A time interval of execution of the management task execution process may be determined in advance or specified by an input from the physical storage administrator or the like. In the present example, it is assumed that the management task execution process is executed in a separate thread to other processes such as the management operation registration process.

In step S3000, the configuration management program 4110 periodically refers to the management task table 4150.

Next, in step S3010, for each management task in the management task table 4150, the configuration management program 4110 compares the current time point and the execution start time point 41503 in the management task table 4150 and determines whether or not there is a management task whose execution start time point 41503 precedes the current time point. When there is no management task whose execution start time point 41503 precedes the current time point, the configuration management program 4110 terminates the present flow. When there is a management task whose execution start time point 41503 precedes the current time point, the configuration management program 4110 causes the process to make a transition to step S3020.

In step S3020, the configuration management program 4110 selects a management task whose execution start time point 41503 precedes the current time point as a selected task, and refers to the task parameter 41502 of the selected task to determine whether or not the selected task specifies a virtual ID. When the selected task specifies a virtual ID, the configuration management program 4110 causes the process to make a transition to step S3030. If not, the configuration management program 4110 causes the process to make a transition to step S3060. At this point, for example, if the IDs of the selected task which is registered in the task parameter 41502 are the storage ID 413E0 and the volume ID 413E1 in the volume information table 413E or the like, the configuration management program 4110 determines that a physical ID has been specified, and if the IDs of the selected task which is registered in the task parameter 41502 are the virtual storage ID 41380 and the virtual volume ID 41381 in the volume information table 413E or the like, the configuration management program 4110 determines that a virtual ID has been specified. For example, the management operation registered by the virtual configuration management program 4111 specifies a virtual operation target (virtual ID). In addition, an inter-enclosure data migration registered by the configuration management program 4110 specifies an operation target (physical ID).

Next, in step S3030, based on the volume information table 413E, the configuration management program 4110 respectively converts the virtual storage ID and the virtual volume ID specified by the selected task into a storage ID and a volume ID. Specifically, the configuration management program 4110 specifies an entry having a set of the virtual storage ID 41380 and the virtual volume ID 41381 which matches the set of the virtual storage ID and the virtual volume ID included in the task parameter 41502 of the selected task from entries of the volume information table 413E and acquires the storage ID 413E0 and the volume ID 413E1 of the entry. Moreover, when step S3030 is executed in a state where an inter-enclosure data migration is not executed, only one set of the storage ID and the volume ID is acquired with respect to one set of the virtual storage ID and the virtual volume ID. On the other hand, when step S3030 is executed in a state where an inter-enclosure data migration is being executed, two sets of the storage ID and the volume ID including a set of a storage ID and a volume ID representing the migration source volume and a set of a storage ID and a volume ID representing the migration destination volume are acquired with respect to one set of the virtual storage ID and the virtual volume ID.

Next, in step S3040, the configuration management program 4110 determines whether or not the logical volume 1110 specified by the storage ID and the volume ID is in the midst of an inter-enclosure data migration. As described above, when step S3030 is executed in a state where an inter-enclosure data migration is being executed, two sets of the storage ID and the volume ID are acquired. In consideration thereof, the configuration management program 41110 may determine whether or not an inter-enclosure data migration is in progress based on the number of acquired sets of the storage ID and the volume ID. When it is determined that the logical volume 1110 is in the midst of an inter-enclosure data migration, the configuration management program 4110 causes the process to make a transition to step S3050. When it is determined that the logical volume 1110 is not in the midst of an inter-enclosure data migration, the configuration management program 4110 causes the process to make a transition to step S3060.

In step S3050, the configuration management program 4110 performs a management operation conversion process in which a management operation that specifies a virtual operation target is converted into a management operation that specifies an operation target (target storage apparatus). In addition, the management operation conversion process selects an operation target from a migration source volume and a migration destination volume corresponding to the virtual operation target. Details of the management operation conversion process will be given later.

Next, in step S3060, the configuration management program 4110 generates a command of a management operation such as a configuration change which has been converted by the management operation conversion process and issues (transmits) the command to the storage apparatus 1000 that is specified as a target of the management operation via the I/F 4300. Moreover, depending on the type of the management operation, the command may be issued via the configuration management program 2120 on the host computer 2000.

Next, in step S3070, the configuration management program 4110 collects configuration information of the storage apparatus 1000 and the virtual storage apparatus 6000 which has been changed by the executed management operation and reflects the collected configuration information in the tables in the memory 4100.

Next, in step S3080, the configuration management program 4110 deletes the executed management task from the management task table 4150 and terminates the present flow.

This concludes the description of the management task execution process. According to this process, the configuration management program 4110 can execute a registered management task.

In the present example, the configuration management program 4110 performs a first management operation conversion process described below as the management operation conversion process of S3050 described earlier.

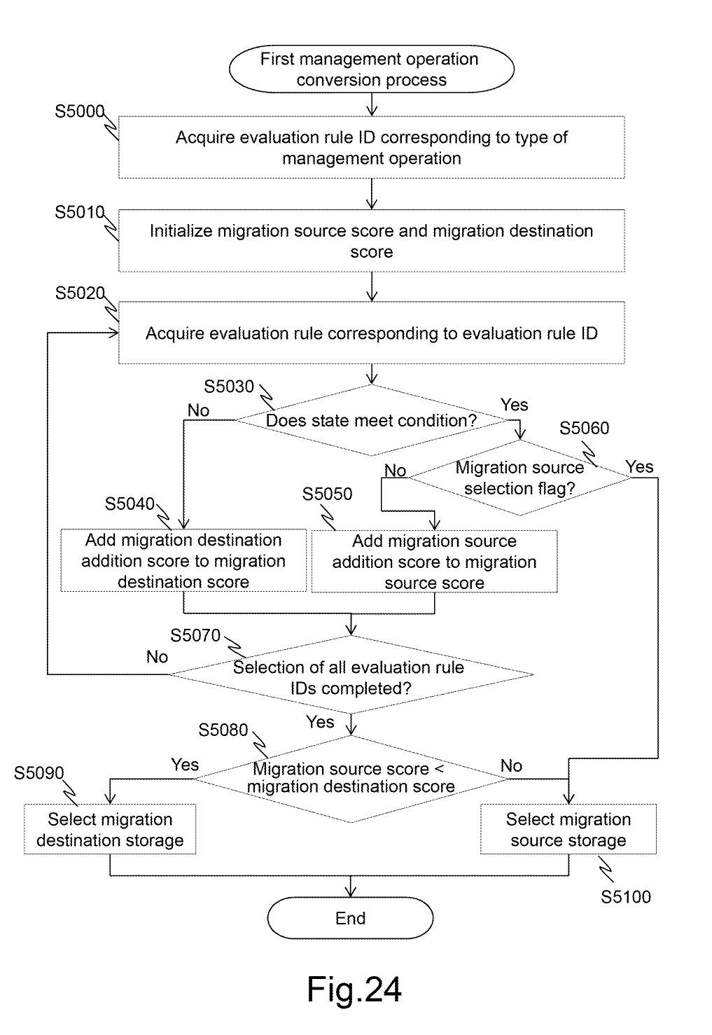

FIG. 24 shows the first management operation conversion process.

In the first management operation conversion process, the configuration management program 4110 selects any of a migration source volume and a migration destination volume corresponding to a virtual operation target as an operation target and converts a management operation that specifies the virtual operation target into a management operation that specifies the selected operation target.

In step S5000, the configuration management program 4110 acquires the task type 41501 of the selected task from the management task table 4150, selects an entry having a task type 41610 that matches the acquired task type from the entries of the management operation evaluation table 4161, and acquires an evaluation rule ID in the evaluation rule IO 41613 of the entry. For example, when a restore destination (copy source) volume is in the midst of an inter-enclosure data migration during execution of a management operation of “a remote copy restore”, 1, 2, 3, 4, and 5 are acquired as evaluation rule IDs.

Next, in step S5010, the configuration management program 4110 initializes the migration source score and the migration destination score and sets the respective values of the migration source score and the migration destination score to 0.

Next, in step S5020, the configuration management program 4110 selects one of the acquired evaluation rule IDs and acquires an evaluation rule corresponding to the selected evaluation rule ID from the evaluation rule table 4162.

Next, in step S5030, the configuration management program 4110 determines whether or not the state of the storage system meets the condition 41621 of the acquired evaluation rule. In this case, the configuration management program 4110 determines the state of the storage system based on the volume information table 413E, the processor performance information table 4141, the port performance information table 4121, the pool performance information table 4143, the cache performance information table 4144, and the like. When it is determined that the state does not meet the condition, the configuration management program 4110 causes the process to make a transition to step S5040. When it is determined that the state meets the condition, the configuration management program 4110 causes the process to make a transition to step 35060.

In step S5040, the configuration management program 4110 adds the migration destination addition score 41624 of the acquired evaluation rule from the evaluation rule table 4162 to the migration destination score.

In step S5060, the configuration management program 4110 determines whether or not the evaluation rule selected from the evaluation rule table 4162 indicates selecting the migration source storage as an operation target. At this point, when the migration source selection flag 41622 corresponding to the selected evaluation rule ID is “Yes”, the configuration management program 4110 determines that the evaluation rule indicates that the migration source storage is inevitably selected as the operation target. In other words, the configuration management program 4110 determines that the evaluation rule indicates that the migration destination storage cannot be selected as the operation target. At this point, when the migration source selection flag 41622 is “Yes”, the configuration management program 4110 causes the process to make a transition to step S5100, and if not, the configuration management program 4110 causes the process to make a transition to step S050.

In step S5050, the configuration management program 4110 adds the migration source addition score 41623 of the acquired evaluation rule from the evaluation rule table 4162 to the migration source score.

Next, in step S5070, the configuration management program 4110 determines whether or not selection of all of the acquired evaluation rule IDs has been completed. When the selection of all of the evaluation rule IDs has been completed, the configuration management program 4110 causes the process to make a transition to step S5080, and if not, the configuration management program 4110 causes the process to make a transition to step S5020 to select a next evaluation rule ID.

In step S5080, the configuration management program 4110 determines whether or not the migration destination score is higher than the migration source score. When the migration destination score is higher than the migration source score, the configuration management program 4110 causes the process to make a transition to step S5090, and if not, the configuration management program 4110 causes the process to make a transition to step S5100.

In step S5090, the configuration management program 4110 selects the migration destination volume as the operation target, converts the management operation that specifies a virtual operation target into a management operation that specifies the selected operation target, stores the converted management operation in the memory 4100, and terminates the present flow. The operation target is identified by a storage ID and a volume ID of the migration destination. Subsequently, the configuration management program 4110 causes the management task execution process to make a transition to step S3060 and issues a command of the management operation to be performed on the migration destination volume.

In step S5100, the configuration management program 4110 selects the migration source volume as the operation target, converts the management operation that specifies a virtual operation target into a management operation that specifies the selected operation target, stores the converted management operation in the memory 4100, and terminates the present flow. The operation target is identified by a storage ID and a volume ID of the migration source. Subsequently, the configuration management program 4110 causes the management task execution process to make a transition to step S3060, generates a command of the management operation to be performed on the migration source volume, and transmits the command to the storage apparatus 1000 that is the operation target.

This concludes the description of the first management operation conversion process. According to this process, the management computer 4000 can select an optimum operation target and generate a command with respect to the operation target in accordance with a type of remote copy operation and a state of the storage system. In addition, by selecting an optimum operation target based on loads on the resources of the migration source storage and the migration destination storage, a decline in performance of the storage system can be prevented. Furthermore, by calculating respective evaluation values of the migration source storage and the migration destination storage based on loads on a plurality of resources of the migration source storage and the migration destination storage, an optimum operation target can be selected. Moreover, by selecting the migration source storage as an operation target when the migration destination storage does not include a control volume, management operation failures can be prevented.

Hereinafter, details of step S5030 described earlier will be presented.

The configuration management program 4110 having selected the evaluation rule (1) selects all entries whose values of the storage ID 413E0 indicate the migration destination storage from the volume information table 413E and acquires the control flags 413E6 of the selected entries as migration destination control flags. Subsequently, when “Yes” is included in the migration destination control flags, the configuration management program 4110 determines that the state of the storage system meets the acquired condition 41621.

The configuration management program 4110 having selected the evaluation rule (2) acquires the migration destination control flags described above and, at the same time, selects all entries whose values of the storage ID 413E0 indicate the migration source storage from the volume information table 413E, and acquires the control flags 413E6 of the selected entries as migration source control flags. Subsequently, when “Yes” is included in the migration destination control flags and, at the same time, “Yes” is not included in the migration source control flags, the configuration management program 4110 determines that the state of the storage system meets the acquired condition 41621.

The evaluation rule (3) is applied when a restore destination volume (copy source volume) is in the midst of an inter-enclosure data migration during execution of a remote copy restore. In this case, the configuration management program 4110 performs the following processes.

(S5231) The configuration management program 4110 selects an entry having a set of the copy source storage ID 413A1 and the copy source volume ID 413A2 which indicates the set of the migration source storage and the migration source volume from the copy pair information table 413A and acquires the copy source port ID 413A3 of the entry as the migration source port ID.

(S5232) in a similar manner, the configuration management program 4110 selects an entry having a set of the copy source storage ID 413A1 and the copy source volume ID 413A2 which indicates the set of the migration destination storage and the migration destination volume from the copy pair information table 413A and acquires the copy source port ID 413A3 of the entry as the migration destination port ID.

(S5233) The configuration management program 4110 selects an entry whose port ID 41420 indicates the migration source port ID from the port performance information table 4142 and acquires the transfer amount 41422 of the entry as a migration source port transfer amount. Furthermore, the configuration management program 4110 selects an entry whose port ID 41420 indicates the migration destination port ID from the port performance information table 4142 and acquires the transfer amount 41422 of the entry as a migration destination port transfer amount.

(S5234) The configuration management program 4110 uses the migration source port transfer amount and the migration destination port transfer amount to determine whether or not the state of the storage system meets the condition 41621.

The evaluation rule (6) is applied when a restore source volume (copy destination volume, is in the midst of an inter-enclosure data migration during execution of a remote copy restore. In this case, the configuration management program 4110 performs S5231b and S5232b described below in place of S5231 and 35232 in the processing of the evaluation rule (3).

(S5231b) The configuration management program 4110 selects an entry having a set of the copy destination storage ID 413A4 and the copy destination volume ID 413A5 which indicates the set of the migration source storage and the migration source volume from the copy pair information table 413A and acquires the copy destination port ID 413A6 of the entry as the migration source port ID.

(S5232b) The configuration management program 4110 selects an entry having a set of the copy destination storage ID 413A4 and the copy destination volume ID 413A5 which indicates the set of the migration destination storage and the migration destination volume from the copy pair information table 413A and acquires the copy destination port ID 413A6 of the entry as the migration destination port ID.

The evaluation rule (4) is applied in a similar manner to the evaluation rule (3) when a restore destination volume is in the midst of an inter-enclosure data migration during a remote copy restore. In this case, the configuration management program 4110 performs the following processes.

(S5241) The configuration management program 4110 selects an entry having a set of the storage ID 413E0 and the volume ID 413E1 which indicates the set of the migration source storage and the migration source volume from the volume information table 413E and acquires the processor ID 413E5 of the entry as the migration source processor ID.

(S5242) The configuration management program 4110 selects an entry having a set of the storage ID 413E0 and the volume ID 413E1 which indicates the set of the migration destination storage and the migration destination volume from the volume information table 413E and acquires the processor ID 413E5 of the entry as the migration destination processor ID.

(S5243) The configuration management program 4110 selects an entry whose processor ID 41410 indicates the migration source processor ID from the processor performance information table 4141 and acquires the usage 41412 of the entry as a migration source processor usage. Furthermore, the configuration management program 4110 selects an entry whose processor ID 41410 indicates the migration destination processor ID from the processor performance information table 4141 and acquires the usage 41412 of the entry as a migration destination processor usage.

(S5244) The configuration management program 4110 uses the migration source processor usage and the migration destination processor usage to determine whether or not the state of the storage system meets the condition 41621.

The evaluation rule (7) and the evaluation rule (9) are also evaluated according to a similar procedure as the evaluation rule (4).

The evaluation rule (5) is applied when a restore destination volume (copy source volume) is in the midst of an inter-enclosure data migration during execution of a remote copy restore. In this case, the configuration management program 4110 performs the following processes.

(S5251) The configuration management program 4110 selects an entry whose copy group ID 413A8 indicates a restore target copy group from the copy pair information table 413A and acquires the copy source storage ID 413A1 and the copy source volume ID 413A2 of the entry.

(S5252) The configuration management program 4110 determines whether or not inter-enclosure data migrations of all logical volumes 1110 identified by the acquired copy source storage ID 413A1 and the copy source volume ID 413A2 have been completed based on the management task table 4150.

The evaluation rule (8) is applied when a copy source volume is in the midst of an inter-enclosure data migration during a remote copy pair creation. In this case, the configuration management program 4110 performs S5231c and S5232c described below in place of S5231 and S5232 in the processing of the evaluation rule (3).

(S5231c) The configuration management program 4110 selects an entry having a set of the copy source storage ID 413A1 and the copy source volume ID 413A2 which indicates the set of the migration source storage and the migration source volume from the copy pair information table 413A and acquires the copy source port ID 413A3 of the entry as the migration source port ID.

(S5232c) In a similar manner, the configuration management program 4110 selects an entry having a set of the copy source storage ID 413A1 and the copy source volume ID 413A2 which indicates the set of the migration destination storage and the migration destination volume from the copy pair information table 413A and acquires the copy source port ID 413A3 of the entry as the migration destination port ID. Moreover, the configuration management program 4110 may specify a migration source port ID and a migration destination port ID in an instruction of a remote copy pair creation based in an input from the physical storage administrator. Since port IDs that can be used for remote copying are determined in advance for each storage apparatus 1000, the configuration management program 4110 may specify such ports as the migration source port ID and the migration destination port ID.

The evaluation according to the evaluation rule (10) uses the cache performance information table 4144 in place of the processor performance information table 4141 in the evaluation according to the evaluation rule (4).

The evaluation according to the evaluation rule (11) uses the pool performance information table 4143 in place of the processor performance information table 4141 in the evaluation according to the evaluation rule (4).

According to the processes described above, the management computer 4000 can select an appropriate operation target when issuing a management operation that specifies a virtual operation target to the storage apparatus 1000. For example, when the restore destination volume (copy source volume) is in the midst of an inter-enclosure data migration when a remote copy restore operation is executed, an optimum restore destination can be selected among the migration source volume and the migration destination volume. In this case, by calculating and comparing a migration source score in a case of a restore to the migration source volume and a migration destination score in a case of a restore to the migration destination volume according to the evaluation rules, the management computer 4000 can select a restore destination volume that can be efficiently restored.

According to the present example, when a management operation is instructed by specifying a virtual ID, an appropriate physical ID corresponding to the virtual ID can be identified in accordance with the state of the storage system. As a result, even when the virtual storage administrator instructs a management operation without being conscious of the state of the physical storages, the management operation can be executed in an efficient manner.

### Example 2

When a logical volume corresponding to a virtual volume specified as a virtual operation target is in the midst of an inter-enclosure data migration, there may be cases where a management operation cannot be executed or a management operation can be executed but is not effective even if the virtual operation target can be converted into an operation target.

For example, let us assume that, due to a management operation registration process, the virtual configuration management program 4111 has registered a management operation of a volume removal with respect to a certain virtual volume based on an input by the virtual storage administrator. When a target volume that is the logical volume 1110 allocated to the virtual volume is not in the midst of an inter-enclosure data migration, the configuration management program 4110 need only identify a target volume that corresponds to the virtual volume and remove the target volume. However, when the target volume is in the midst of an inter-enclosure data migration, there are two target volumes, namely, a migration source volume and a migration destination volume, that correspond to the virtual volume. In consideration of the purpose of a volume removal, removing only one of the migration source volume and the migration destination volume is not sufficient.

In the following description, a process of converting a management operation registered by the virtual configuration management program 4111 into a different management operation may sometimes be referred to as conversion or expansion.

In the present example, differences from Example 1 will be mainly described and similarities with Example 1 will not be described.

Hereinafter, a configuration of a computer system according to Example 2 will be described.

In the present example, since configurations of the computer system, the storage apparatus 1000, and the host computer 2000 are similar to those in Example 1, a description thereof will be omitted.

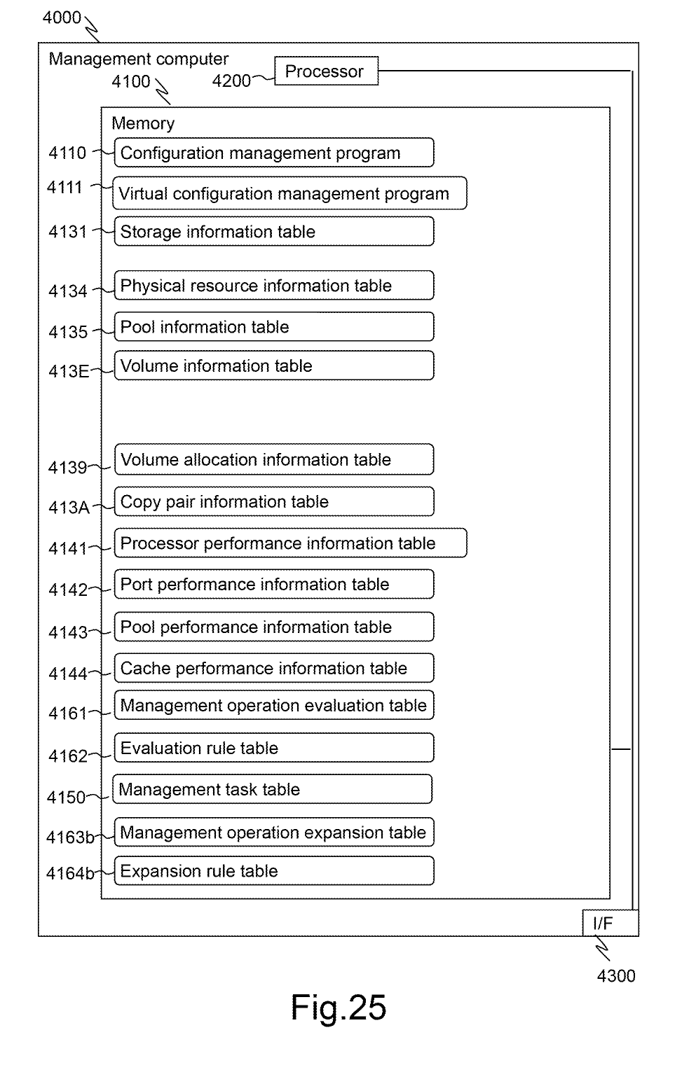

FIG. 25 shows a configuration of the management computer 4000 according to Example 2.

Compared to the memory 4100 according to Example 1, the memory 4100 according to Example 2 stores a management operation expansion table 4163b and an expansion rule table 4164b in addition to the programs and tables according to Example 1.

Hereinafter, tables stored in the management computer 4000 will be described.

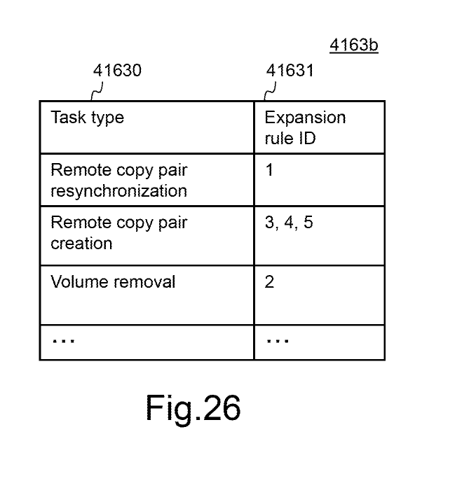

FIG. 26 shows a configuration of the management operation expansion table 4163b.

The management operation expansion table 4163b shows identifiers of expansion rules that are used when expanding a management operation of a certain task type.

The management operation expansion table 4163b includes a task type 41630 and an expansion rule ID 41631. One entry in the management operation expansion table 4163b corresponds to one task type 41630. An expansion rule ID is an identifier of an expansion rule corresponding to the task type. In the following description, an expansion rule whose expansion rule ID is i (where i is an integer) may sometimes be referred to as an expansion rule (i).

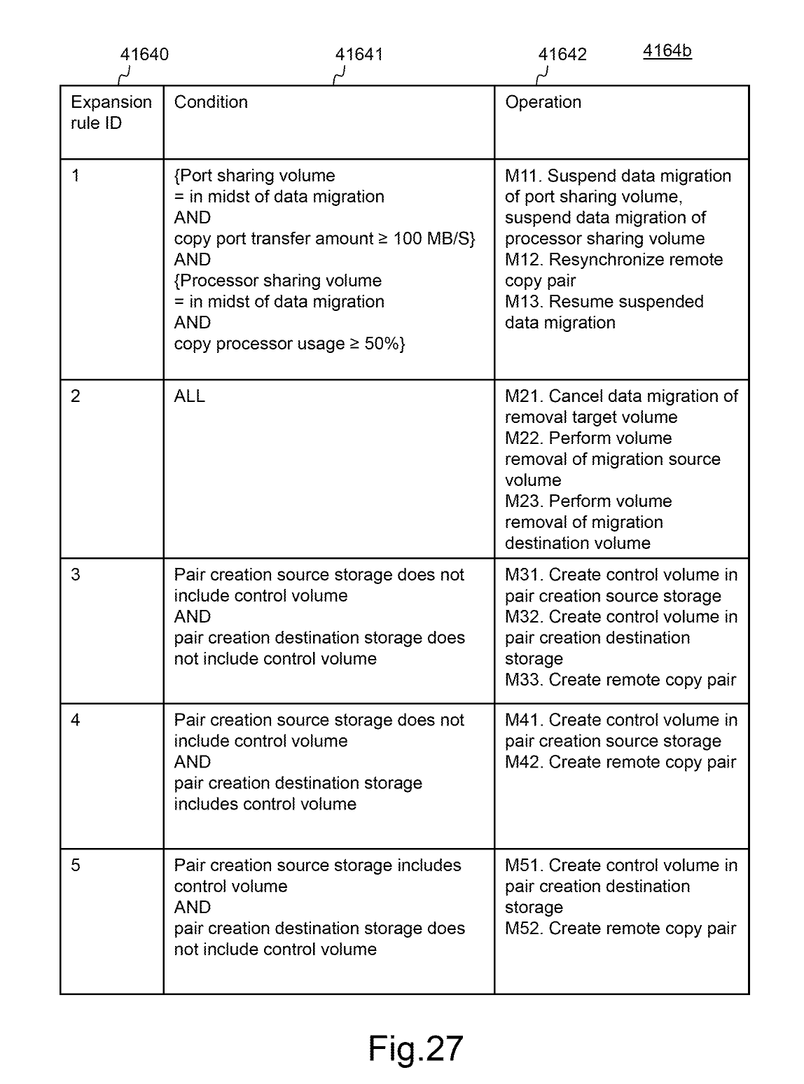

FIG. 27 shows a configuration of the expansion rule table 4164b.

The expansion rule table 4164b is a table that manages expansion rules that are rules for expanding a management operation into a different management operation.

The management operation expansion table 4163b includes an expansion rule ID 41640, a condition 41641, and an operation 41642. One entry in the management operation expansion table 4163b corresponds to one expansion rule. The expansion rule ID 41640 is an identifier of a certain expansion rule. The condition 41641 represents a condition of a state of the storage system for expanding a management operation using the expansion rule. The operation 41642 represents an operation of the configuration management program 4110 when the state of the storage system meets the condition. When the state of the storage system meets the condition 41641 of the expansion rule corresponding to the task type during execution of the management operation by the configuration management program 4110, the registered management operation is expanded to a management operation indicated by the operation 41642 and executed.

Hereinafter, details of the expansion rules will be described.

Let us assume that the virtual configuration management program 4111 has registered a management operation of a remote copy pair resynchronization that specifies a virtual ID based on an input from the virtual storage administrator. In this case, the configuration management program 4110 selects an expansion rule (1) when executing the management operation. At this point, it is assumed that a virtual operation target is in the midst of an inter-enclosure data migration in a similar manner to the management task execution process according to Example 1. The condition 41641 of the expansion rule (1) is that the state of the storage system meets all of conditions C11 to C16 below.

(C11) When a copy source volume and a copy destination volume that are targets of the remote copy pair resynchronization are assumed to be a resynchronization target volume group and a port used by the resynchronization target volume group for remote copying is assumed to be a copy port, a port sharing volume exists which is a logical volume 1110 that shares the copy port with the resynchronization target volume group.

(C12) The port sharing volume is in the midst of an inter-enclosure data migration.

(C13) The port transfer amount of the copy port is equal to or larger than 100 MB/s.

(C14) When a processor used by the resynchronization target volume group is assumed to be a copy processor, a processor sharing volume exists which is a logical volume 1110 that shares the copy processor with the resynchronization target volume group.

(C15) The processor sharing volume is in the midst of an inter-enclosure data migration.

(C16) The usage of the copy processor is equal to or higher than 50%.

When the state of the storage system meets the condition 41641 of the expansion rule (1), the configuration management program 4110 executes the management operation of a remote copy pair resynchronization which specifies a virtual ID by expanding the management operation to a management operation involving suspension of an inter-enclosure data migration (M11), a remote copy pair resynchronization that specifies a physical ID (M12), and resuming of the suspended inter-enclosure data migration (M13). M11 includes suspension of an inter-enclosure data migration of a port sharing volume and suspension of an inter-enclosure data migration of a processor sharing volume. M13 includes resuming of an inter-enclosure data migration of a port sharing volume and resuming of an inter-enclosure data migration of a processor sharing volume. In this case, if the port sharing volume and the processor sharing volume are assumed to be resource sharing volumes, the configuration management program 4110 selects resource sharing volumes and storage apparatuses 1000 that include the resource sharing volumes and transmits a command to suspend an inter-enclosure data migration to the selected storage apparatuses 1000. In addition, the configuration management program 4110 selects a storage apparatus 1000 and a logical volume 1110 corresponding to the virtual ID of the remote copy pair resynchronization and transmits a command for the remote copy pair resynchronization of the selected logical volume 1110 to the selected storage apparatus 1000. Furthermore, the configuration management program 4110 transmits a command for resuming an inter-enclosure data migration to the storage apparatus 1000 selected in M11.

Let us assume that the virtual configuration management program 4111 has registered a management operation for a volume removal based on an input from the virtual storage administrator. In this case, the configuration management program 4110 selects an expansion rule (2) when executing the management operation. Registration of “ALL” in the condition 41641 means that a corresponding operation 41642 is unconditionally executed when execution of a corresponding management operation is instructed. In this case, when a virtual volume 6110 that is a target of a volume removal is assumed to be a removal target volume, the configuration management program 4110 executes a management operation of a volume removal that specifies the virtual ID by expanding the management operation to cancellation of an inter-enclosure data migration of the removal target volume (M21), a volume removal of a migration source volume of the an inter-enclosure data migration (M22), and a volume removal of a migration destination volume of the inter-enclosure data migration (M23). At this point, the configuration management program 4110 selects the migration source volume and a storage apparatus 1000 including the migration source volume, and transmits a command for cancelling the inter-enclosure data migration and a command for a volume removal to the selected storage apparatus 1000. Furthermore, the configuration management program 4110 selects the migration destination volume and a storage apparatus 1000 including the migration destination volume and transmits a command for a volume removal to the selected storage apparatus 1000. According to the expansion rule (2), when removing the virtual volume 6110 during the inter-enclosure data migration, both a migration source volume and a migration destination volume corresponding to the virtual volume 6110 can be reliably removed.

Let us assume that the virtual configuration management program 4111 has registered a management operation for a remote copy pair creation based on an input from the virtual storage administrator. In this case, the configuration management program 4110 selects an expansion rule (3), an expansion rule (4), and an expansion rule (5) when executing the management operation.

The condition 41641 of the expansion rule (3) is that there is no control volume in a copy source (pair creation source) storage of the copy pair to be created and that there is no control volume in a copy destination (pair destination source) storage of the copy pair. When the state of the storage system meets the condition 41641 of the expansion rule (3), the configuration management program 4110 executes a management operation of a remote copy pair creation that specifies the virtual ID by expanding the management operation to control volume creation in the copy source storage (M31), control volume creation in the copy destination storage (M32), and a remote copy pair creation that specifies a physical ID (M33). At this point, the configuration management program 4110 selects a copy source storage and a copy destination storage, and transmits a command for a control volume creation and a command for a remote copy pair creation to the selected storage apparatus 1000.

The condition 41641 of the expansion rule (4) is that a copy source (pair creation source) storage of the copy pair to be created does not include a control volume and that a copy destination (pair creation destination) storage of the copy pair includes a control volume. When the state of the storage system meets the condition 41641 of the expansion rule (4), the configuration management program 4110 executes a management operation of a remote copy pair creation that specifies the virtual ID by expanding the management operation to control volume creation in the copy source storage (M41) and a remote copy pair creation that specifies a physical ID (M42). At this point, the configuration management program 4110 selects a copy source storage and transmits a command for control volume creation to the selected storage apparatus 1000. Furthermore, the configuration management program 4110 selects a copy source storage and a copy destination storage and transmits a command for a remote copy pair creation to the selected storage apparatus 1000.

The condition 41641 of the expansion rule (5) is that a copy source (pair creation source) storage of the copy pair to be created includes a control volume and that a copy destination (pair creation destination) storage of the copy pair does not include a control volume. When the state of the storage system meets the condition 41641 of the expansion rule (5), the configuration management program 4110 executes a management operation of a remote copy pair creation that specifies the virtual ID by expanding the management operation to control volume creation in the copy destination storage (M51) and a remote copy pair creation that specifies a physical ID (M52). At this point, the configuration management program 4110 selects a copy destination storage and transmits a command for control volume creation to the selected storage apparatus 1000. Furthermore, the configuration management program 4110 selects a copy source storage and a copy destination storage and transmits a command for a remote copy pair creation to the selected storage apparatus 1000.

According to the expansion rules (3), (4), and (5), by creating a control volume in a storage apparatus 1000 in which a control volume does not exist among the copy source storage and the copy destination storage during execution of remote copy creation, failures in remote copy creation can be prevented and a copy pair can be created in a reliable manner.

Hereinafter, operations of the management computer 4000 will be described.

Since the inter-enclosure data migration registration process, the management operation registration process, and the management task execution process are similar to those according to Example 1, a description thereof will be omitted.

In the present example, as the management operation conversion process of S3050 described earlier, the configuration management program 4110 performs a second management operation conversion process after the first management operation conversion process.

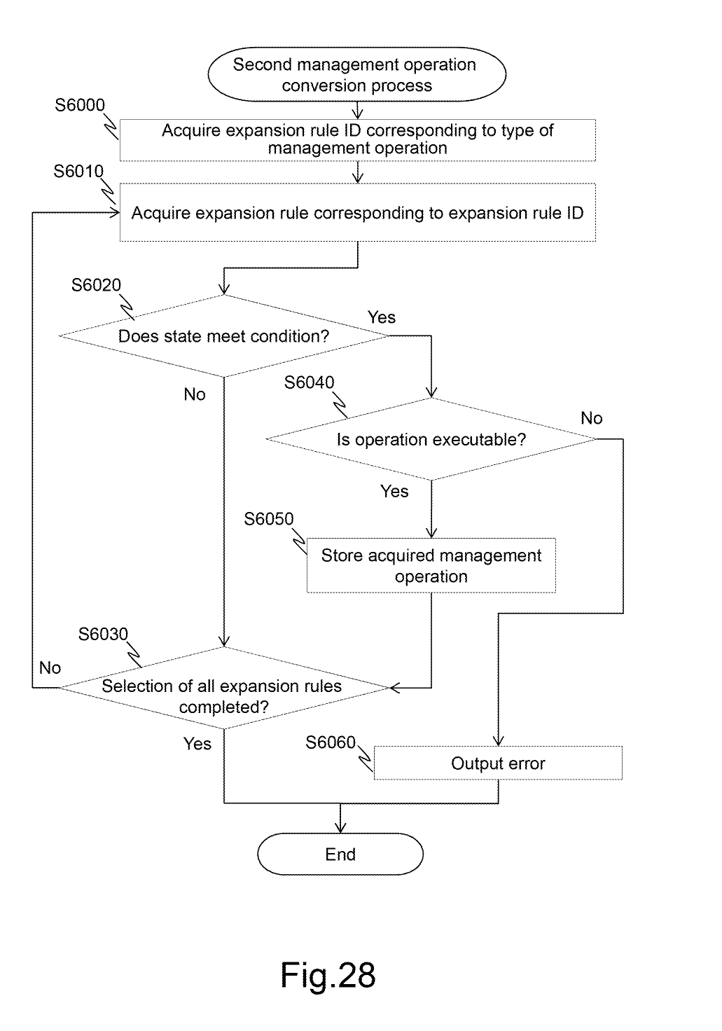

FIG. 28 shows the second management operation conversion process.

In the second management operation conversion process, the configuration management program 4110 converts (expands) a management operation registered by the virtual configuration management program 4111 into a management operation that can be executed by the storage apparatus 1000.

In step S6000, the configuration management program 4110 acquires expansion rule IDs corresponding to a type of the management operation from the management operation expansion table 4163b.

Next, in step S6010, the configuration management program 4110 selects one of the acquired expansion rule IDs and acquires an expansion rule corresponding to the selected expansion rule ID from the expansion rule table 4164b.

Next, in step S6020, the configuration management program 4110 determines whether or not the state of the storage system meets the condition 41641 of the acquired expansion rule. If the state meets the condition, the configuration management program 4110 causes the process to make a transition to step S6040, and if not, the configuration management program 4110 causes the process to make a transition to step S6030.

In step S6040, the configuration management program 4110 determines whether or not the storage apparatus 1000 that is an operation target is capable of executing the operation 41642 of the acquired expansion rule. When the operation can be executed, the configuration management program 4110 causes the process to make a transition to step 36050, and if not, the configuration management program 4110 causes the process to make a transition to step S6060.

In step S6050, the configuration management program 4110 stores the operation 41642 of the acquired expansion rule in the memory 4100. At this point, the configuration management program 4110 may register the operation 41642 of the acquired expansion rule in the management task table 4150.

Next, in step S6030, the configuration management program 4110 determines whether or not selection of all of the acquired expansion rules has been completed. If selection has been completed, the present flow is terminated, and if not, the configuration management program 4110 causes the process to make a transition to step S6010 to select a next expansion rule ID.

In step S6060, the configuration management program 4110 outputs an error via the user interface and terminates the present flow.

This concludes the description of the second management operation conversion process.

For example, let us assume that, due to a management operation registration process, the virtual configuration management program 4111 has registered a management operation of a volume removal with respect to a certain virtual volume based on an input by the virtual storage administrator. According to the management task execution process, the configuration management program 4110 acquires an operation target corresponding to the virtual operation target. In addition, since the evaluation rule corresponding to a volume removal is not included in the management operation evaluation table 4161, the configuration management program 4110 skips the first management operation conversion process.

In the second management operation conversion process, since the management operation is a volume removal, the configuration management program 4110 expands the management operation of a volume removal according to the expansion rule (2). Since the condition 41641 of the expansion rule (2) is “ALL”, the operation 41642 is unconditionally acquired. At this point, the configuration management program 4110 cancels (stops) the inter-enclosure data migration of the removal target volumes and removes the migration source volume and the migration destination volume. At this point, the configuration management program 4110 may remove the migration source volume and the migration destination volume after shredding data stored in the migration source volume and the migration destination volume. In this case, a management operation for performing shredding is set as the corresponding operation 41642.

In addition, for example, let us assume that, due to a management operation registration process, the virtual configuration management program 4111 has registered a management operation of a remote copy pair creation using a certain virtual volume based on an input by the virtual storage administrator. According to the management task execution process, the configuration management program 4110 acquires an operation target corresponding to the virtual operation target. At this point, it is assumed that a copy source volume is in the midst of an inter-enclosure data migration. The configuration management program 4110 acquires physical IDs of a migration source volume and a migration destination volume in correspondence with the virtual IO of the copy source volume. According to the first management operation conversion process, the configuration management program 4110 determines which of the migration source volume and the migration destination volume is to be subjected to the management operation. Moreover, according to Example 1, when the management operation is a remote copy pair creation, the configuration management program 4110 performs evaluations based on the evaluation rules (1), (2), (8), (9), (10), and (11). However, in the present example, the conditions 41621 of evaluation rules other than the evaluation rule (1) are confirmed in order to determine whether the migration source volume or the migration destination volume is to be selected as the copy source volume. This is because, in the present example, since a control volume is created in a storage apparatus including the copy source volume if the storage apparatus does not have a control volume, the migration source storage need not necessarily be selected even if the migration destination storage does not have a control volume. In this case, let us assume that the migration destination volume has been selected as the copy source volume.

Subsequently, the configuration management program 4110 performs the second management operation conversion process. When the management operation is a remote copy pair creation command, the management operation for a remote copy pair creation is expanded according to the expansion rule (4). The condition 41641 of the evaluation rule (4) is that there is no control volume in the copy source storage. In this case, since the migration destination volume has been selected as the copy source volume, the configuration management program 4110 confirms whether or not the migration destination storage has a control volume, and if not, executes the operation 41642. According to the present example, the configuration management program 4110 creates a control volume in the migration destination storage and executes a remote copy pair creation.

In addition, for example, let us assume that, due to a management operation registration process, the virtual configuration management program 4111 has registered a management operation of a remote copy pair resynchronization using a certain virtual volume based on an input by the virtual storage administrator. According to the second management operation conversion process, the configuration management program 4110 executes suspension of an inter-enclosure data migration that affects the speed of the remote copy pair resynchronization, subsequently executes the remote copy pair resynchronization and, thereafter, resumes the suspended inter-enclosure data migration. Accordingly, the configuration management program 4110 can give a higher priority to the remote copy pair resynchronization than an inter-enclosure data migration.

Moreover, when the ports and processors used for remote copying are under a high load, the expansion rule (1) ends up suspending all inter-enclosure data migrations of resource sharing volumes (a post sharing volume and a processor sharing volume) that are the logical volumes 1110 sharing the ports and processors. In consideration thereof, the expansion rule (1) may be configured to suspend only an inter-enclosure data migration whose progress is slower than a prescribed threshold. In this case, the configuration management program 4110 may use the progress shown in the execution state 41504 in the management task table 4150 or may calculate progress based on a time as measured from a current time point to the estimated execution completion time point 41505. In addition, the expansion rule (1) may be configured to set a priority to each of a plurality of inter-enclosure data migrations and suspend the inter-enclosure data migrations whose priorities are lower than a prescribed threshold. As described above, the expansion rule (1) may be configured to suspend an inter-enclosure data migration only in a specific logical volume 1110 among the resource sharing volumes. Furthermore, the expansion rule (1) may have a rule that includes referring to the execution state 41504 of the management task table 4150, determining whether or not the inter-enclosure data migration of the resource sharing volume is to be completed by or within a certain time from the current time, and when it is determined that the inter-enclosure data migration of the resource sharing volume is to be completed by or within a certain time from the current time, a remote copy pair resynchronization is performed after awaiting the completion of the inter-enclosure data migration instead of suspending the inter-enclosure data migration. In addition, when a plurality of inter-enclosure data migrations are being executed during the execution of a management task of a remote copy pair resynchronization, an inter-enclosure data migration that affects the speed of the remote copy pair resynchronization may be selected and suspended.

Moreover, the configuration management program 4110 may change an execution order of management tasks in the management task table 4150 based on the estimated execution completion time point 41505 in the management task table 4150. For example, before instructing execution of a management operation to the storage apparatus 1000, the configuration management program 4110 estimates the estimated execution completion time point 41505 in the management task table 4150 based on configuration information and performance information of the storage apparatus 1000 and determines whether or not the estimated execution completion time point 41505 of the final management task precedes a completion time point that is set in advance. When the estimated execution completion time point 41505 does not precede the completion time point, the configuration management program 4110 acquires a management task whose execution state 41504 in the management task table 4150 is “unexecuted” and changes the execution start time point 41503 to interchange an execution order of the acquired management task and once again estimates the estimated execution completion time point 41505. When the interchanged execution order satisfies the requirement of completion time point, the configuration management program 4110 executes the management task in the execution order. The completion time point may be set by the virtual configuration management program 4111 based on an input by the virtual storage administrator or may be set by the configuration management program 4110 based on an input by the physical storage administrator. Accordingly, a plurality of management tasks can be executed in an execution order that meets the requirement of completion times.

Moreover, the management operation conversion process need not necessarily include the first management operation conversion process. In addition, a part of the evaluation rules or a part of the expansion rules may be omitted.

The management operation conversion process is capable of generating a command for specifying an appropriate logical volume 1110 based on a management operation for specifying a virtual operation target such as the virtual volume 6110. In addition, the management operation conversion process is capable of generating one or a plurality of appropriate commands based on a management operation of any of a remote copy operation and a volume operation.

According to the present example, when executing a management operation registered by the virtual storage administrator, the configuration management program 4110 can perform conversion of the management operation such as adding a management operation in accordance with the state of the storage system and cause the storage apparatus 1000 to execute the converted management operation. For example, when a removal target volume is in the midst of an inter-enclosure data migration during execution of a volume removal, the configuration management program 4110 may convert the management operation so as to remove both the migration source volume and the migration destination volume and execute the management operation in an appropriate manner.

In addition, the configuration management program 4110 is capable of converting a management operation registered based on an input by the virtual storage administrator into an appropriate command and issue the command of the management operation to an appropriate storage apparatus 1000 without having the virtual storage administrator be conscious of the configuration of the storage apparatus 1000.

The techniques described in the examples above can be expressed as follows.

### (Expression 1)

A storage management computer including:

a communication control device coupled to a first storage apparatus and a second storage apparatus;
a memory configured to store state information indicating states of the first storage apparatus and the second storage apparatus; and
a processor coupled to the communication control device and the memory, wherein
the processor is configured to acquire an operation instruction which instructs an operation for changing a configuration of a virtual storage apparatus that uses the first storage apparatus and the second storage apparatus, and is configured to, when the operation instruction is executed during an inter-enclosure data migration from the first storage apparatus to the second storage apparatus, select a target storage apparatus from the first storage apparatus and the second storage apparatus based on the operation instruction and the state information, generate an operation command that instructs an operation for changing a configuration of the target storage apparatus, and transmit the operation command to the target storage apparatus.

### (Expression 2)

The storage management computer according to Expression 1, wherein

the operation instruction specifies a virtual volume in the virtual storage apparatus and instructs a change in a configuration of the virtual volume, and
the operation command specifies a target volume corresponding to the virtual volume in the target storage apparatus and instructs a change in a configuration of the target volume.

### (Expression 3)

The storage management computer according to Expression 2, wherein

the communication control device is further coupled to a third storage apparatus, and
the operation instruction instructs any one of an operation of remote copy using a specific volume in the third storage apparatus and the virtual volume as a pair and an operation to be performed on the virtual volume.

### (Expression 4)

The storage management computer according to Expression 3, wherein

the processor is configured to, when the operation instruction is an instruction of any of restore and pair creation of the remote copy, select any one of the first storage apparatus and the second storage apparatus as the target storage apparatus based on the state information, generate the operation command instructing any of the restore and the pair creation with respect to the target volume, and transmit the operation command to the target storage apparatus.

### (Expression 5)

The storage management computer according to Expression 4, wherein

the state information represents a load on a resource that is used for the remote copy among the first storage apparatus and the second storage apparatus, and
the processor is configured to, when the operation instruction is an instruction of any of the restore and the pair creation, select the target storage apparatus based on the load on the resource.

### (Expression 6)

The storage management computer according to Expression 5, wherein

the processor is configured to receive information representing the load on the resource from the first storage apparatus and the second storage apparatus and store the received information in the memory.

### (Expression 7)

The storage management computer according to Expression 6, wherein

the state information represents whether or not the second storage apparatus includes a control volume for executing a process in accordance with the operation command, and the processor is configured to, when the operation instruction is an instruction of any of the restore and the pair creation and the second storage apparatus does not include a control volume, select the first storage apparatus as the target storage apparatus.

### (Expression 8)

The storage management computer according to Expression 6, wherein

the state information represents whether or not each of the first storage apparatus, the second storage apparatus, and the third storage apparatus includes a control volume for executing a process in accordance with the operation command, and
the processor is configured to, when the operation instruction is an instruction of the pair creation, select a storage apparatus that does not include a control volume among the target storage apparatus and the third storage apparatus as a specific storage apparatus based on the state information, generate a control volume creation command that instructs creation of a control volume in the specific storage apparatus, transmit the control volume creation command to the specific storage apparatus, and transmit the operation command to the target storage apparatus.

### (Expression 9)

The storage management computer according to Expression 3, wherein

the state information represents a load on a resource that is used for any of the remote copy and the inter-enclosure data migration among the first storage apparatus, the second storage apparatus, and the third storage apparatus, and when the operation instruction is an instruction of pair resynchronization of the remote copy and a load on a resource that is used for the remote copy and the inter-enclosure data migration in the target storage apparatus meets a prescribed load condition, a suspend command that instructs suspension of the inter-enclosure data migration, the operation command that instructs the pair resynchronization to the target storage apparatus, and a resume command that instructs resuming of the inter-enclosure data migration are generated, the suspend command is transmitted to the target storage apparatus, the operation command is transmitted to the target storage apparatus, and the resume command is transmitted to the target storage apparatus.

### (Expression 10)

The storage management computer according to Expression 3, wherein

the processor is configured to, when the operation instruction is an instruction for removing the virtual volume, generate a stop command for stopping the inter-enclosure data migration, select the first storage apparatus and the second storage apparatus as the target storage apparatus, generate the operation command that instructs removal of a volume corresponding to the virtual volume in the target storage apparatus, transmit the stop command to the target storage apparatus, and transmit the operation command to the target storage apparatus.

### (Expression 11)

The storage management computer according to Expression 5, wherein

the state information represents a load on a plurality of resources that are used for the remote copy among the first storage apparatus and the second storage apparatus, and the processor is configured to, when the operation instruction instructs any of the restore and the pair creation, calculate an evaluation value of each of the first storage apparatus and the second storage apparatus based on the load on the plurality of resources and select a storage apparatus with a high evaluation value among the first storage apparatus and the second storage apparatus as the target storage apparatus.

### (Expression 12)

The storage management computer according to Expression 3, wherein

the processor is configured to acquire a plurality of operation instructions that instruct operations of the virtual storage apparatus, store the plurality of operation instructions in the memory, acquire a request for completion time points of the plurality of operation instructions, estimate estimated completion time points at which operations in accordance with the plurality of operation instructions are to be completed based on the state information, and change an execution order of the plurality of operation instructions based on the request for completion time points and the estimated completion time points.

### (Expression 13)

A storage control method including:

using a management computer which is coupled to a first storage apparatus and a second storage apparatus and which is configured to store state information indicating states of the first storage apparatus and the second storage apparatus, to acquire an operation instruction which instructs an operation for changing a configuration of a virtual storage apparatus that uses the first storage apparatus and the second storage apparatus; and
when the operation instruction is executed during an inter-enclosure data migration from the first storage apparatus to the second storage apparatus, using the management computer to select a target storage apparatus among the first storage apparatus and the second storage apparatus based on the operation instruction and the state information, generate an operation command that instructs an operation for changing a configuration of the target storage apparatus, and transmit the operation command to the target storage apparatus.

### (Expression 14)

A storage system including:

a first storage apparatus;
a second storage apparatus; and
a management computer coupled to the first storage apparatus and the second storage apparatus, wherein
the management computer includes:
a communication control device coupled to the first storage apparatus and the second storage apparatus;
a memory configured to store state information indicating states of the first storage apparatus and the second storage apparatus; and
a processor coupled to the communication control device and the memory, and wherein
the processor is configured to acquire an operation instruction which instructs an operation for changing a configuration of a virtual storage apparatus that uses the first storage apparatus and the second storage apparatus, and is configured to, when the operation instruction is executed during an inter-enclosure data migration from the first storage apparatus to the second storage apparatus, select a target storage apparatus from the first storage apparatus and the second storage apparatus based on the operation instruction and the state information, generate an operation command that instructs an operation for changing a configuration of the target storage apparatus, and transmit the operation command to the target storage apparatus.

Terms used in the expressions presented above will be described. The storage management computer corresponds to the management computer 4000 and the like. The first storage apparatus corresponds to the migration source storage and the like. The second storage apparatus corresponds to the migration destination storage and the like. The communication control device corresponds to the I/F 4300 and the like. The state information corresponds to configuration information, performance information, and the like. The resource corresponds to the I/F (A) 1230, the processor 1220, the cache memory 1260, and the like.

### REFERENCE SIGNS LIST

1000 Storage apparatus
1100 Disk apparatus
1110 Logical volume
1120 Pool
1121 Physical resource
1220 Processor
1210 Control memory
1260 Cache memory
1200 Disk controller
2000 Host computer
4000 Management computer
6000 Virtual storage apparatus
6110 Virtual volume

1. A storage management computer comprising:
a communication control device coupled to a first storage apparatus and a second storage apparatus;
a memory configured to store state information indicating states of the first storage apparatus and the second storage apparatus; and
a processor coupled to the communication control device and the memory, wherein
the processor is configured to acquire an operation instruction which instructs an operation for changing a configuration of a virtual storage apparatus that uses the first storage apparatus and the second storage apparatus, and is configured to, when the operation instruction is executed during an inter-enclosure data migration from the first storage apparatus to the second storage apparatus, select a target storage apparatus from the first storage apparatus and the second storage apparatus based on the operation instruction and the state information, generate an operation command that instructs an operation for changing a configuration of the target storage apparatus, and transmit the operation command to the target storage apparatus.

2. The storage management computer according to claim 1, wherein the operation instruction specifies a virtual volume in the virtual storage apparatus and instructs a change in a configuration of the virtual volume, and
the operation command specifies a target volume corresponding to the virtual volume in the target storage apparatus and instructs a change in a configuration of the target volume.

3. The storage management computer according to claim 2, wherein the communication control device is further coupled to a third storage apparatus, and
the operation instruction instructs any one of an operation of remote copy using a specific volume in the third storage apparatus and the virtual volume as a pair and an operation to be performed on the virtual volume.

4. The storage management computer according to claim 3, wherein the processor is configured to, when the operation instruction is an instruction of any of restore and pair creation of the remote copy, select any one of the first storage apparatus and the second storage apparatus as the target storage apparatus based on the state information, generate the operation command instructing any of the restore and the pair creation with respect to the target volume, and transmit the operation command to the target storage apparatus.

5. The storage management computer according to claim 4, wherein the state information represents a load on a resource that is used for the remote copy among the first storage apparatus and the second storage apparatus, and
the processor is configured to, when the operation instruction is an instruction of any of the restore and the pair creation, select the target storage apparatus based on the load on the resource.

6. The storage management computer according to claim 5, wherein the processor is configured to receive information representing the load on the resource from the first storage apparatus and the second storage apparatus and store the received information in the memory.

7. The storage management computer according to claim 6, wherein the state information represents whether or not the second storage apparatus includes a control volume for executing a process in accordance with the operation command, and the processor is configured to, when the operation instruction is an instruction of any of the restore and the pair creation and the second storage apparatus does not include a control volume, select the first storage apparatus as the target storage apparatus.

8. The storage management computer according to claim 6, wherein the state information represents whether or not each of the first storage apparatus, the second storage apparatus, and the third storage apparatus includes a control volume for executing a process in accordance with the operation command, and
the processor is configured to, when the operation instruction is an instruction of the pair creation, select a storage apparatus that does not include a control volume among the target storage apparatus and the third storage apparatus as a specific storage apparatus based on the state information, generate a control volume creation command that instructs creation of a control volume in the specific storage apparatus, transmit the control volume creation command to the specific storage apparatus, and transmit the operation command to the target storage apparatus.

9. The storage management computer according to claim 3, wherein the state information represents a load on a resource that is used for any of the remote copy and the inter-enclosure data migration among the first storage apparatus, the second storage apparatus, and the third storage apparatus, and when the operation instruction is an instruction of pair resynchronization of the remote copy and a load on a resource that is used for the remote copy and the inter-enclosure data migration in the target storage apparatus meets a prescribed load condition, a suspend command that instructs suspension of the inter-enclosure data migration, the operation command that instructs the pair resynchronization to the target storage apparatus, and a resume command that instructs resuming of the inter-enclosure data migration are generated, the suspend command is transmitted to the target storage apparatus, the operation command is transmitted to the target storage apparatus, and the resume command is transmitted to the target storage apparatus.

10. The storage management computer according to claim 3, wherein the processor is configured to, when the operation instruction is an instruction for removing the virtual volume, generate a stop command for stopping the inter-enclosure data migration, select the first storage apparatus and the second storage apparatus as the target storage apparatus, generate the operation command that instructs removal of a volume corresponding to the virtual volume in the target storage apparatus, transmit the stop command to the target storage apparatus, and transmit the operation command to the target storage apparatus.

11. The storage management computer according to claim 5, wherein the state information represents a load on a plurality of resources that are used for the remote copy among the first storage apparatus and the second storage apparatus, and the processor is configured to, when the operation instruction instructs any of the restore and the pair creation, calculate an evaluation value of each of the first storage apparatus and the second storage apparatus based on the load on the plurality of resources and select a storage apparatus with a high evaluation value among the first storage apparatus and the second storage apparatus as the target storage apparatus.

12. The storage management computer according to claim 3, wherein the processor is configured to acquire a plurality of operation instructions that instruct operations of the virtual storage apparatus, store the plurality of operation instructions in the memory, acquire a request for completion time points of the plurality of operation instructions, estimate estimated completion time points at which operations in accordance with the plurality of operation instructions are to be completed based on the state information, and change an execution order of the plurality of operation instructions based on the request for completion time points and the estimated completion time points.

13. A storage control method comprising:
using a management computer which is coupled to a first storage apparatus and a second storage apparatus and which is configured to store state information indicating states of the first storage apparatus and the second storage apparatus, to acquire an operation instruction which instructs an operation for changing a configuration of a virtual storage apparatus that uses the first storage apparatus and the second storage apparatus; and
when the operation instruction is executed during an inter-enclosure data migration from the first storage apparatus to the second storage apparatus, using the management computer to select a target storage apparatus among the first storage apparatus and the second storage apparatus based on the operation instruction and the state information, generate an operation command that instructs an operation for changing a configuration of the target storage apparatus, and transmit the operation command to the target storage apparatus.

14. A storage system comprising:
a first storage apparatus;
a second storage apparatus; and
a management computer coupled to the first storage apparatus and the second storage apparatus, wherein
the management computer includes:
a communication control device coupled to the first storage apparatus and the second storage apparatus;
a memory configured to store state information indicating states of the first storage apparatus and the second storage apparatus; and
a processor coupled to the communication control device and the memory, and wherein
the processor is configured to acquire an operation instruction which instructs an operation for changing a configuration of a virtual storage apparatus that uses the first storage apparatus and the second storage apparatus, and is configured to, when the operation instruction is executed during an inter-enclosure data migration from the first storage apparatus to the second storage apparatus, select a target storage apparatus from the first storage apparatus and the second storage apparatus based on the operation instruction and the state information, generate an operation command that instructs an operation for changing a configuration of the target storage apparatus, and transmit the operation command to the target storage apparatus.
